(19) United States
(12) Patent Application Publication
(10) Pub. No.: US 2024/0260512 A1
(43) Pub. Date: Aug. 8, 2024

(54) Compositions And Devices For Baling Bulk Crops Provided In Heterogeneous Or Homogeneous Manners, Techniques And Methods Of Use Thereof

(71) Applicant: Tama Group, Kibbutz Mishmar Ha'emek (IL)

(72) Inventors: Reuven Hugi, Nahariya (IL); Tsafrir Lior, Kibbutz Mishmar Ha' Emek (IL); Sivan Ginat, Kibbutz Mishmar Ha' Emek (IL); Uri Blich, Ha' Emek (IL); Stella Ostrovsky, St. Pardesiya (IL); Nicka Chinkov, Kibbutz Mishmar Ha' Emek (IL)

(73) Assignee: Tama Group, Kibbutz Mishmar Ha'emek (IL)

(21) Appl. No.: 18/277,712

(22) PCT Filed: Mar. 13, 2022
(86) PCT No.: PCT/IL2022/050283

§ 371 Date: Aug. 17, 2023

(30) Foreign Application Priority Data
Mar. 14, 2021 (IL) 281494

(51) Int. Cl. A01F 15/07; A01F 15/08

(52) U.S. Cl. CPC A01F 15/0715; A01F 15/0816; A01F 2015/0745

(57) ABSTRACT

The present invention inter alia discloses an environmentally friendly, and optionally either edible or allowed to be in contact with food, baling materials, methods of its production and use, and a baler utilizing environmentally friendly binding materials for baling. The invention defines the baling materials in both chemical and physical manners. The present invention further discloses means and method for protecting the environment.

### FIELD OF THE PRESENT DISCLOSURE

The present disclosure relates to environmentally friendly compositions, materials, devices, techniques, and methods for treating bulk crops such as hay, silage, straw, grass, alfalfa, cotton, and the like or any combination thereof, in order to improve the baling and storage of such crops. The present invention also pertains to baling bulk crops provided in either heterogeneous or homogeneous manners.

### BACKGROUND OF THE PRESENT DISCLOSURE

The current standard for organizing and baling bulk crops involves wrapping the collected crop in a material such as netting or plastic wrap. Such a technique is disclosed, for example, in U.S. Pat. No. 5,596,864, and US2014/000745. However, these methods do not completely prevent loss due to rot and mold.

Particularly with the use of plastic wrapping material, one drawback of the technology is the creation of agricultural plastic waste in the form of polyethylene material. See Dorado, Christina, Charles A. Mullen, and Akwasi A. Boateng. “Coprocessing of agricultural plastic waste and switchgrass via tail gas reactive pyrolysis.” Industrial & Engineering Chemistry Research 54.40 (2015): 9887-9893. Pieces of this plastic wrap can end up intermingled with the crop itself, contaminating the crop. Further, upon removal of the plastic material, it is disposed of through landfilling, incineration, and recycling. Because of their persistence in the environment, several communities are now more sensitive to the impact of discarded plastic on the environment, including deleterious effects on wildlife and on the aesthetic qualities of cities and forests. Improperly disposed plastic materials are a significant source of environmental pollution, potentially harming life. In addition, the burning of polyvinylchloride plastics produces persistent organic pollutants known as furans and dioxins Kasirajan, Subrahmaniyan, and Mathieu Ngouajio. “Polyethylene and biodegradable mulches for agricultural applications: a review.” Agronomy for Sustainable Development 32.2 (2012): 501-529.

Rumen impaction due to non-metallic foreign bodies is among the most common cause of gastrointestinal disorders in ruminants. Plastic materials are widely utilized in the agricultural industry, and as it is usually not disposed of in a correct manner, the plastic waste can be eaten by the grazing animals. The incidence of non-metallic foreign bodies, mostly polythene material, was disclosed in the literature to be mostly found in cows, see Akraiem, A., and Abd Al-Galil. “Rumen impaction in cattle due to plastic materials.” J. Vet. Med. Res. 23 (2016): 65-66. Agrotechnology is thus seeking solutions targeted to promote animal health and hence look to use materials considered to be animal-safe.

Once a bulk crop, such as hay, is cut, it is left in the field to dry, then raked into windrows. The hay is then baled by baling machines, and the bales are then placed in storage. These bales may be either rectangular or cylindrical. One advantage of cylindrical baling is that the baler is generally cheaper than a baling machine used for rectangular bales. Another significant advantage is that it is harder for water to penetrate a round bale, so they are less susceptible to rot and mold. However, due to their size, these bales are usually stored outdoors and are thus, exposed to rain. Despite the advantageous cylindrical shape, the outer layers are still more vulnerable, and after prolonged storage, up to 25% of the hay may not be usable. An additional problem is the need to wrap the bales, in order to prevent the outer layers becoming loose during handling

One approach that has been attempted to replace the use of plastic or like materials is the utilization of a composition for the coating of the crop, such as hay, with a water-repellent protective layer, thus preventing water damage. U.S. Pat. No. 4,846,890 discloses such a method. However, this method utilized costly chemicals that may have detrimental effects on the environment, or on the animals ingesting the hay coated with these chemicals.

Thus, there remains a need to develop a low-cost and environmentally friendly and animal-safe composition, device, material, technique, and methods for outdoor storage of baled crops, such as hay, cotton, flax straw, corn straw, wheat straw, grass, alfalfa, salt marsh hay, silage, and the like, or any combination thereof, which may prevent loss of crop due to mold and handling. It is the object of this present disclosure to provide a composition for the binding of bales of crop and that the composition of the binder is such that it may prevent formation of mold. In addition, this binder should be such that the baled crop remains intact during handling.

### BRIEF DESCRIPTION OF DRAWINGS

The accompanying drawings, which are included to provide a further understanding of the present disclosure and constitute a part of this specification, illustrate certain embodiments of the present disclosure and, together with the written description, serve to explain various aspects of the present disclosure; wherein:

FIGS. 1A and 1B schematically depict a cross section and a schematic three-dimensional view of bales according to various embodiments of the present disclosure; and

Photos 2A-N show bales of crops, e.g., silage, hay and straw bound and packed according to certain examples set forth herein, pertaining to various embodiments of the present disclosure.

### SUMMARY OF THE PRESENT DISCLOSURE

An object of the present invention is to disclose a method of binding a mass into a bale, the bale including at least one inner layer and at least one external layer, the method comprising, administering a binding material to the mass. The method is valid wherein at least one of the following is held true: the concentration (% wt) of the binding material at the at least one (i) external cross-section layer (L) [C^{Li}ₒᵤₜ] is higher than the at least one (j) inner cross-section layer [CL^{j}ᵢₙ]; i and j are integers each of which is equal to or is greater than 1 and [C^{Li}ₒᵤₜ]>[CL^{j}ᵢₙ]; the concentration (% wt) of the binding material at the external cross-section layers decreases so that [C^{Li=n}ₒᵤₜ]>[C^{Li=(n+1)}ₒᵤₜ], n is an integer equal to or greater than 1, where n increases with each successive layer further from the external surface of the bound mass; the concentration (% wt) of the binding material at the outermost external cross-section layer [Cₒᵤₜ] is higher than at the innermost cross-section layer [Cᵢₙ]; the concentration (% wt) of the binding material at the outermost cross-section layer is f times higher than at the innermost cross-section layer, and f≥1.5; the concentration (% wt) of the binding material relative to the bound mass at the outermost cross-section layer is [Cₒᵤₜ]≥0.4%, whilst the concentration of the binding material relative to the bound mass within the innermost cross-section layer is [Cᵢₙ]≤0.2%; the bale characterized by a solid geometry having an equator, wherein concentration (% wt) of the binding material relative to the bound mass at the at least one external cross-section layer along the equator [C^{Eq}ₒᵤₜ] is higher than within the at least one inner cross-section layer (j) [C^{Lj}ₒᵤₜ]; concentration (% wt) of the binding material relative to the bound mass in at least one external cross-section layer along the equator [C^{Eq}ₒᵤₜ] is higher than in at least one external cross-section layer along at least one of its parallels of constant latitude, [C^{Pr}ₒᵤₜ]; concentration (% wt) of the binding material relative to the bound mass at the outermost external cross-section layer along the equator [C^{Eq}ₒᵤₜ] is higher than at the outermost external cross-section layer along at least one of its parallels of constant latitude, [C^{Pr}ₒᵤₜ]; concentration (% wt) of the binding material relative to the bound mass in at least one external cross-section layer along the bales's latitudes [C^{LAT}ₒᵤₜ] is higher than in at least one external cross-section layer along at least one of its meridians or constant longitude [C^{Mer}ₒᵤₜ]; concentration (% wt) of the binding material relative to the bound mass at the outermost external cross-section layer along the latitudes of the bale [C^{LAT}ₒᵤₜ] is higher than at the outermost external cross-section layer along at least one of its meridians or constant longitude [C^{Mer}ₒᵤₜ]; concentration (% wt) of the binding material relative to the bound mass at one or more external cross-section layers of one or more portions (a) [C^{PORa}ₒᵤₜ] of the bales surface or adjacent external cross-section layers is higher than one or more external cross-section layers of one or more other portions (b) [C^{PORb}ₒᵤₜ]; concentration (% wt) of the binding material relative to the bound mass at two or more external cross-section layers of two or more portions (a) [C^{PORa}ₒᵤₜ] of the bale surface or adjacent external cross-section layers is higher than one or more external cross-section layers of one or more other portions (b) [C^{PORb}ₒᵤₜ] so that a net-like enveloping portion of high concentration of the binding material [C^{PORa}ₒᵤₜ] is provided; the administering is selected from one or more members of a group consisting of sprinkling, dripping, wetting, socking, spraying, dousing, dampening, applying a metered dose or otherwise dosing or batching fluid or fluids being in various states, e.g., gas, liquids, solids, flowable fine particles and particulate matter or combination thereof; and the administering is provided in a plurality of steps, at least one first step of providing the mass pre-wetted (dry or semi-dry) solid binding materials; and at least one second step of wetting the mass and solid binders by a fluid; the administering is provided in a plurality of steps, at least one first step of providing the mass pre-wetted (dry or semi-dry) solid binding materials; and at least one second step of wetting the mass and solid binders by a fluid; the first and second steps are provided at separate locations and/or separate time: the first and second steps are provided at the same location and/or at the adjacent time; and the administering is provided in a plurality of steps, at least one first step of providing the mass pre-wetted (dry or semi-dry) solid binding materials; and at least one second step of wetting the mass and solid binders by a fluid; the first and second steps are provided at separate locations and/or separate time.

Another object of the present invention is to disclose the method as defined in any of the variants above, wherein mass is cut and raked crop including hay, cotton, flax straw, corn straw, wheat straw, salt marsh hay or silage, or any combination thereof.

Another object of the present invention is to disclose the method as defined in any of the variants above, wherein the method further comprising step or series of steps of applying pressure to the mass. The step or steps of applying pressure is potentially applied before, during, and/or after the administering step.

Another object of the present invention is to disclose the method as defined in any of the variants above, wherein binding materials are either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from about 10 to about 1,500 μm; (a)/(b) weight ratio ranging from about 100:40 to about 0.5:10. Thermoplasticized natural polymers are utilizable. The natural polymers may include lignocellulosic materials and derivatives thereof. The term “about” refers hereinafter to any value being up to 25% greater or lower than the defined measure.

Another object of the present disclosure is to disclose the method as defined in any of the variant above, wherein binding materials are elected from either or both food grade materials and food contact materials.

Another object of the present invention is to disclose the method as defined in any of the variants above, wherein at least one of the following is held true: (a) food grade biding materials are selected from a group consisting of cellulose UFC-100, size ranging from about 8 to about 10 μm; hard wood cellulose is selected from a group consisting of BE 600-10-TG, size ranging from about 18 μm, BE 600-30, size ranging from about 30 μm, HB 4115, size ranging from about 40 to about 110 μm; and soft wood fibers BK 40 90, about 1,500 μm; (b) food contact materials are selected from a group consisting of soft wood Lignocel selected from a group consisting of CW-630-PU, size ranging from about 20 to about 40 μm, C-750-FP, size ranging from about 40 to about 70 μm, C-100, size ranging from about 70 to about 150 μm, C-320, size ranging from about 200 to about 500 μm; soft wood fibers HS-250, size ranging from about 150 to about 350 μm; and (c), food grade propylene glycol and polyvinyl alcohol, 6-88 or 6-96, respectively, are utilizable as an alternative plasticizer to glycerol. The melts are possibly heated to about 180° C.

Another object of the present invention is to disclose the method as defined in any of the variants above, wherein the binding material is a water-based dispersion and at least one of the following is held true: (a) viscosity ranges between 1,040 cP at 25° C. and 121 cP at 60° C. utilizing Brookfield DV2T (b) shear strength ranges between 0.7 to 2.7 MPa according to modified ASTM D 905-03 where thin layer of the dispersions applied on 0.7×0.7-inch area of a wooden veneer with dimensions of 150×2×1.5 mm; after open time of 5 to 20 min, the samples were glued, subjected to the static pressure of 3.5 atm for 3 min and allowed to cure at ambient conditions for at least 48 hours or till constant weight; at least 6 cured assemblies were then tested for shear strength at 5 mm/min speed; and (c) tensile stress at maximum load ranges between 0.3 to 0.5 MPa and Work from preload (toughness) of 200 to 600 N/mm, according modified ASTM D 638-02a, at 50 mm/min speed, where the dispersions were casted into hand-made rectangular patterns of 1.5×2.0 cm thickness and lateral dimensions of 2×15 cm trays and dried at 25° C. and 30% humidity in the climate chamber for at least 6 days;

Another object of the present invention is to disclose a method as defined in any of the variants above, wherein the binding material is a hot-melt and at least one of the following is held true: (a) Tensile stress at maximum load ranges between 1.5 to 2.5 MPa; and (b) Work from preload (toughness) ranges between 200 to 2100 N/mm.

Yet another object of the present invention is to disclose a baler comprising a mass compacting module; and a module for administering a binding material within the mass compacting module. Another object of the present invention is to disclose a baler as defined above, wherein the mass compacting module is capable of housing a mass therein, and the administering module is capable of administering a binding material to the mass housed in the mass compacting module.

Another object of the present invention is to disclose a baler as defined above, wherein the administering module is capable of administering the binding material in a heterogeneous manner. The heterogeneous manner is provided useful wherein at least one of the following is true: the concentration (% wt) of the binding material at the at least one (i) external cross-section layer (L) [C^{Li}ₒᵤₜ] is higher than the at least one (j) inner cross-section layer [C^{Lj}ₒᵤₜ]; i and j are integers each of which is equal to or greater than 1 and [C^{Li}ₒᵤₜ]>[C^{Lj}ᵢₙ]; the concentration (% wt) of the binding material at the external cross-section layers decreases so that [C^{Li=n}ₒᵤₜ]>[C^{Li=(n+1)}ₒᵤₜ], n is an integer equal to or greater than 1, where n increases with each successive layer further from the external surface of the bound mass; the concentration (% wt) of the binding material at the outermost external cross-section layer [Cₒᵤₜ] is higher than at the innermost cross-section layer [Cᵢₙ]; the concentration (% wt) of the binding material at the outermost cross-section layer is f times higher than at the innermost cross-section layer, and f≥1.5; concentration (% wt) of the binding material relative to the bound mass at the outermost cross-section layer [Cₒᵤₜ]≥0.4%, whilst the concentration of the binding material relative to the bound mass within the innermost cross-section layer [Cᵢₙ]≤0.2%; the bale characterized by a solid geometry having an equator, wherein concentration (% wt) of the binding material relative to the bound mass in at least one external cross-section layer along the equator [C^{Eq}ₒᵤₜ] is higher than within the at least one inner cross-section layer (j) [C^{Lj}ₒᵤₜ]; concentration (% wt) of the binding material relative to the bound mass in at least one external cross-section layer along the equator [C^{Eq}ₒᵤₜ] is higher than in at least one external cross-section layer along at least one of its parallels of constant latitude, [C^{Pr}ₒᵤₜ]; concentration (% wt) of the binding material relative to the bound mass at the outermost external cross-section layer along the equator [C^{Eq}ₒᵤₜ] is higher than the outermost external cross-section layer along at least one of its parallels of constant latitude, [C^{Pr}ₒᵤₜ]; concentration (% wt) of the binding material relative to the bound mass in at least one external cross-section layer along the bales's latitudes [C^{LAT}ₒᵤₜ] is higher than in at least one external cross-section layer along at least one of its meridians or constant longitude [C^{Mer}ₒᵤₜ]; concentration (% wt) of the binding material relative to the bound mass at the outermost external cross-section layer along the bales's latitudes [C^{LAT}ₒᵤₜ] is higher than at the outermost external cross-section layer along at least one of its meridians or constant longitude [C^{Mer}ₒᵤₜ]; concentration (% wt) of the binding material relative to the bound mass in one or more external cross-section layers of one or more portions (a) [C^{PORa}ₒᵤₜ] of the bales surface or adjacent external cross-section layers is higher than in one or more external cross-section layers of one or more other portions (b) [C^{PORb}ₒᵤₜ]; concentration (% wt) of the binding material relative to the bound mass in two or more external cross-section layers of two or more portions (a) [C^{PORa}ₒᵤₜ] of the bales surface or adjacent external cross-section layers is higher than one or more external cross-section layers of one or more other portions (b) [C^{PORb}ₒᵤₜ] so that a net-like enveloping portion of high concentration of the binding material [C^{PORa}ₒᵤₜ] is provided; the administering is selected from one or more members of a group consisting of sprinkling, dripping, wetting, socking, spraying, dousing, dampening, applying a metered dose or otherwise dosing or batching fluid or fluids being in various states, e.g., gas, liquids, solids, flowable fine particles and particulate matter or combination thereof; the administering is provided in a plurality of steps, at least one first step of providing the mass pre-wetted (dry or semi-dry) solid binding materials; and at least one second step of wetting the mass and solid binders by a fluid; the administering is provided in a plurality of steps, at least one first step of providing the mass pre-wetted (dry or semi-dry) solid binding materials; and at least one second step of wetting the mass and solid binders by a fluid; the first and second steps are provided at separate locations and/or separate time; the first and second steps are provided at the same location and/or at the adjacent time; and the administering is provided in a plurality of steps, at least one first step of providing the mass pre-wetted (dry or semi-dry) solid binding materials; and at least one second step of wetting the mass and solid binders by a fluid; the first and second steps are provided at separate locations and/or separate time.

Another object of the present invention is to disclose a baler as defined in one or more variants above, wherein the biding materials are either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from about 10 to about 1,500 μm; (a)/(b) weight ratio ranging from about 100:40 to about 0.5:10. Thermoplasticized natural polymers are utilizable. The natural polymers may include lignocellulosic materials and derivatives thereof

Another object of the present invention is to disclose a baler as defined in one or more variants above, wherein biding materials are elected from either or both food grade materials and food contact materials.

Another object of the present invention is to disclose a baler as defined in one or more variants above, wherein at least one of the following is held true: (a) food grade biding materials are selected from a group consisting of cellulose is UFC-100, size ranging from about 8 to about 10 μm; hard wood cellulose is selected from a group consisting of BE 600-10-TG, size ranging from about 18 μm, BE 600-30, size ranging from about 30 μm, HB 4115, size ranging from about 40 to about 110 μm; and soft wood fibers BK 40 90, about 1,500 μm; (b) food contact materials are selected from a group consisting of soft wood Lignocel selected from a group consisting of CW-630-PU, size ranging from about 20 to about 40 μm, C-750-FP, size ranging from about 40 to about 70 μm, C-100, size ranging from about 70 to about 150 μm, C-320, size ranging from about 200 to about 500 μm; soft wood fibers HS-250, size ranging from about 150 to about 350 μm; and (c) food grade propylene glycol and polyvinyl alcohol, 6-88 or 6-96, respectively, are utilizable as an alternative plasticizer to glycerol. The melts are possibly heated to about 180° C.

Another object of the present invention is to disclose a baler as defined in one or more variants above, wherein the binding material is a water-based dispersion and at last one of the following is held true: (a) viscosity ranges between 1,040 cP at 25° C. and 121 cP at 60° C. utilizing Brookfield DV2T: (b) shear strength ranges between 0.7 to 2.7 MPa according to modified ASTM D 905-03 where thin layer of the dispersions applied on 0.7×0.7-inch area of a wooden veneer with dimensions of 150×2×1.5 mm; after open time of 5 to 20 min, the samples were glued, subjected to the static pressure of 3.5 atm for 3 min and allowed to cure at ambient conditions for at least 48 hours or till constant weight; at least 6 cured assemblies were then tested for shear strength at 5 mm/min speed; and (c) tensile stress at maximum load ranges between 0.3 to 0.5 MPa and Work from preload (toughness) of 200 to 600 N/mm, according modified ASTM D 638-02a, at 50 mm/min speed, where the dispersions casted into hand-made rectangular patterns of 1.5×2.0 cm thickness and lateral dimensions of 2×15 cm trays and dried at 25° C. and 30% humidity in the climate chamber for at least 6 days

Another object of the present invention is to disclose a baler as defined in one or more variants above, wherein the binding material is a hot-melt and at last one of the following is held true: (a) Tensile stress at maximum load ranges between 1.5 to 2.5 MPa; and (b) Work from preload (toughness) ranges between 200 to 2100 N/mm.

Still another object of the present invention is to disclose bale of a mass comprising a binding material administered within the mass, so that at least one of the following is true: the concentration (% wt) of the binding material at the at least one (i) external cross-section layer (L) [C^{Li}ₒᵤₜ] is higher than the at least one (j) inner cross-section layer (j) [C^{Lj}ₒᵤₜ]; i and j are integers each of which is equal to or is greater than 1 and [C^{Li}ₒᵤₜ]>[CL^{j}ᵢₙ]; the concentration (% wt) of the binding material at the external cross-section layers decreases so that [C^{Li=n}ₒᵤₜ]>[C^{Li=(n+1)}ₒᵤₜ], n is an integer equal to or greater than 1, where n increases with each successive layer further from the external surface of the bound mass; the concentration (% wt) of the binding material at the outermost external cross-section layer [Cₒᵤₜ] is higher than at the innermost cross-section layer [Cᵢₙ]; the concentration (% wt) of the binding material in the outermost cross-section layer is f times higher than in the innermost cross-section layer, and f≥1.5; the concentration (% wt) of the binding material relative to the bound mass in the outermost cross-section layer [Cₒᵤₜ]≥0.4%, whilst the concentration of the binding material relative to the bound mass within the innermost cross-section layer is [Cᵢₙ]≤0.2%; the bale characterized by a solid geometry having an equator, wherein concentration (% wt) of the binding material relative to the bound mass at the at least one external cross-section layer along the equator [C^{Eq}ₒᵤₜ] is higher than the in at least one inner cross-section layer (j) [C^{Lj}ₒᵤₜ]; concentration (% wt) of the binding material relative to the bound mass in at least one external cross-section layer along the equator [C^{Eq}ₒᵤₜ] is higher than in at least one external cross-section layer along at least one of its parallels of constant latitude, [C^{Pr}ₒᵤₜ]; concentration (% wt) of the binding material relative to the bound mass in the outermost external cross-section layer along the equator [C^{Eq}ₒᵤₜ] is higher than in the outermost external cross-section layer along at least one of its parallels of constant latitude, [C^{Pr}ₒᵤₜ]; concentration (% wt) of the binding material relative to the bound mass in at least one external cross-section layer along the latitudes of the bale [C^{LAT}ₒᵤₜ] is higher than in at least one external cross-section layer along at least one of its meridians or constant longitude [C^{Mer}ₒᵤₜ]; concentration (% wt) of the binding material relative to the bound mass in the outermost external cross-section layer along the bales's latitudes [C^{LAT}ₒᵤₜ] is higher than in the outermost external cross-section layer along at least one of its meridians or constant longitude [C^{Mer}ₒᵤₜ]; concentration (% wt) of the binding material relative to the bound mass in one or more external cross-section layers of one or more portions (a) [C^{PORa}ₒᵤₜ] of the bales surface or adjacent external cross-section layers is higher than in one or more external cross-section layers of one or more other portions (b) [C^{PORb}ₒᵤₜ]; concentration (% wt) of the binding material relative to the bound mass in two or more external cross-section layers of two or more portions (a) [C^{PORa}ₒᵤₜ] of the bales surface or adjacent external cross-section layers is higher than in one or more external cross-section layers of one or more other portions (b) [C^{PORb}ₒᵤₜ] so that a net-like enveloping portion of high concentration of the binding material [C^{PORa}ₒᵤₜ] is provided; the administering is selected from one or more members of a group consisting of sprinkling, dripping, wetting, socking, spraying, dousing, dampening, applying a metered dose or otherwise dosing or batching fluid or fluids being in various states, e.g., gas, liquids, solids, flowable fine particles and particulate matter or combination thereof; and the administering is provided in a plurality of steps, at least one first step of providing the mass pre-wetted (dry or semi-dry) solid binding materials; and at least one second step of wetting the mass and solid binders by a fluid; the administering is provided in a plurality of steps, at least one first step of providing the mass pre-wetted (dry or semi-dry) solid binding materials; and at least one second step of wetting the mass and solid binders by a fluid; the first and second steps are provided at separate locations and/or separate time; the first and second steps are provided at the same location and/or at the adjacent time; and the administering is provided in a plurality of steps, at least one first step of providing the mass pre-wetted (dry or semi-dry) solid binding materials; and at least one second step of wetting the mass and solid binders by a fluid; the first and second steps are provided at separate locations and/or separate time.

Another object of the present invention is to disclose a bale as defined in one or more variants above, wherein the mass is cut and raked crop including hay, cotton, flax straw, salt marsh hay, silage or any combination thereof. Another object of the present invention is to disclose a baler as defined in one or more variants above, wherein biding materials are either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from about 10 to about 1,500 μm; (a)/(b) weight ratio ranging from about 100:40 to about 0.5:10. Another object of the present invention is to disclose a baler as defined in one or more variants above, wherein the biding materials are elected from either or both food grade materials and food contact materials. Thermoplasticized natural polymers are utilizable. The natural polymers may include lignocellulosic materials and derivatives thereof

Another object of the present invention is to disclose a baler as defined in one or more variants above, wherein at least one of the following is held true: (a) food grade biding materials are selected from a group consisting of cellulose UFC-100, size ranging from about 8 to about 10 μm; hard wood cellulose is selected from a group consisting of BE 600-10-TG, size ranging from about 18 μm, BE 600-30, size ranging from about 30 μm, HB 4115, size ranging from about 40 to about 110 μm; and soft wood fibers BK 40 90, about 1,500 μm; (b) food contact materials are selected from a group consisting of soft wood Lignocel selected from a group consisting of CW-630-PU, size ranging from about 20 to about 40 μm, C-750-FP, size ranging from about 40 to about 70 μm, C-100, size ranging from about 70 to about 150 μm, C-320, size ranging from about 200 to about 500 μm; soft wood fibers HS-250, size ranging from about 150 to about 350 μm; and (c) food grade propylene glycol and polyvinyl alcohol, 6-88 or 6-96, respectively, are utilizable as an alternative plasticizer to glycerol. The melts are potentially heated to about 180° C.

Another object of the present invention is to disclose a baler as defined in one or more variants above, wherein the binding material is a water-based dispersion and at last one of the following is held true: (a) viscosity ranges between 1,040 cP at 25° C. and 121 cP at 60° C. utilizing Brookfield DV2T; (b) shear strength ranges between 0.7 to 2.7 MPa according to modified ASTM D 905-03 where thin layer of the dispersions applied on 0.7×0.7-inch area of a wooden veneer with dimensions of 150×2×1.5 mm; after open time of 5 to 20 min, the samples were glued, subjected to the static pressure of 3.5 atm for 3 min and allowed to cure at ambient conditions for at least 48 hours or till constant weight; at least 6 cured assemblies were then tested for shear strength at 5 mm/min speed; and (c) tensile stress at maximum load ranges between 0.3 to 0.5 MPa and Work from preload (toughness) of 200 to 600 N/mm.

Another object of the present invention is to disclose a baler as defined in one or more variants above, wherein the binding material is a hot-melt and at last one of the following is held true: Tensile stress at maximum load ranges between 1.5 to 2.5 MPa; and Work from preload (toughness) ranges between 200 to 2100 N/mm, according modified ASTM D 638-02a, at 50 mm/min speed where the dispersions casted into hand-made rectangular patterns of 1.5×2.0 cm thickness and lateral dimensions of 2×15 cm trays and dried at 25° C. and 30% humidity in the climate chamber for at least 6 days

Another object of the present invention is to disclose a method of promoting animal health by minimizing their consumption of plastic waste comprising utilizing plastic-free binding materials for baling a crop. Another object of the present invention is to disclose a method for promoting animal health as defined in one or more variants above, wherein the binding materials are free of polyalkenes, including polyethylene.

Another object of the present invention is to disclose a method for promoting animal health as defined in one or more variants above, wherein the biding materials are either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from about 10 to about 1,500 μm; (a)/(b) weight ratio ranging from about 100:40 to about 0.5:10. Thermoplasticized natural polymers are utilizable. The natural polymers may include lignocellulosic materials and derivatives thereof

Another object of the present invention is to disclose a method for promoting animal health as defined in one or more variants above, wherein the biding materials are elected from either or both food grade materials and food contact materials.

Another object of the present invention is to disclose a method for promoting animal health as defined in one or more variants above, wherein at least one of the following is held true: (a) food grade biding materials are selected from a group consisting of cellulose UFC-100, size ranging from about 8 to about 10 μm; hard wood cellulose is selected from a group consisting of BE 600-10-TG, size ranging from about 18 μm, BE 600-30, size ranging from about 30 μm, HB 4115, size ranging from about 40 to about 110 μm; and soft wood fibers BK 40 90, about 1,500 μm; (b) food contact materials are selected from a group consisting of soft wood Lignocel selected from a group consisting of CW-630-PU, size ranging from about 20 to about 40 μm, C-750-FP, size ranging from about 40 to about 70 μm, C-100, size ranging from about 70 to about 150 μm, C-320, size ranging from about 200 to about 500 μm; soft wood fibers HS-250, size ranging from about 150 to about 350 μm; and (c) food grade propylene glycol and polyvinyl alcohol, 6-88 or 6-96, respectively, are utilizable as an alternative plasticizer to glycerol. Melts can be heated to about 180° C.

Another object of the present invention is to disclose a method for promoting animal health as defined in one or more variants above, wherein the binding material is a water-based dispersion and at last one of the following is held true: (a) viscosity ranges between 1,040 cP at 25° C. and 121 cP at 60° C. utilizing Brookfield DV2T; (b) shear strength ranges between 0.7 to 2.7 MPa according to modified ASTM D 905-03 where thin layer of the dispersions applied on 0.7×0.7-inch area of a wooden veneer with dimensions of 150×2×1.5 mm; after open time of 5 to 20 min, the samples were glued, subjected to the static pressure of 3.5 atm for 3 min and allowed to cure at ambient conditions for at least 48 hours or till constant weight: at least 6 cured assemblies were then tested for shear strength at 5 mm/min speed; and (c) tensile stress at maximum load ranges between 0.3 to 0.5 MPa and Work from preload (toughness) of 200 to 600 N/mm, according modified ASTM D 638-02a, at 50 mm/min speed where the dispersions casted into hand-made rectangular patterns of 1.5×2.0 cm thickness and lateral dimensions of 2×15 cm trays and dried at 25° C. and 30% humidity in the climate chamber for at least 6 days

Another object of the present invention is to disclose a method for promoting animal health as defined in one or more variants above, wherein the binding material is a hot-melt and at last one of the following is held true: (a) Tensile stress at maximum load ranges between 1.5 to 2.5 MPa; and (b) Work from preload (toughness) ranges between 200 to 2100 N/mm.

Lastly, another object of the present invention is to disclose an environmentally friendly method of minimizing plastic waste in fields of crops, comprising utilizing plastic-free binding material for baling the crops.

Another object of the present invention is to disclose an environmentally friendly method of minimizing plastic waste in fields of crops as defined above, wherein the biding materials are either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from about 10 to about 1,500 μm; (a)/(b) weight ratio ranging from about 100:40 to about 0.5:10. Thermoplasticized natural polymers are utilizable. The natural polymers may include lignocellulosic materials and derivatives thereof

Another object of the present invention is to disclose an environmentally friendly method of minimizing plastic waste in fields of crops as defined above, wherein the biding materials are elected from either or both food grade materials and food contact materials.

Another object of the present invention is to disclose an environmentally friendly method of minimizing plastic waste in fields of crops as defined above, wherein at least one of the following is held true: (a) food grade biding materials are selected from a group consisting of cellulose UFC-100, size ranging from about 8 to about 10 μm; hard wood cellulose is selected from a group consisting of BE 600-10-TG, size ranging from about 18 μm, BE 600-30, size ranging from about 30 μm, HB 4115, size ranging from about 40 to about 110 μm; and soft wood fibers BK 40 90, about 1,500 μm; (b) food contact materials are selected from a group consisting of soft wood Lignocel selected from a group consisting of CW-630-PU, size ranging from about 20 to about 40 μm, C-750-FP, size ranging from about 40 to about 70 μm, C-100, size ranging from about 70 to about 150 μm, C-320, size ranging from about 200 to about 500 μm; soft wood fibers HS-250, size ranging from about 150 to about 350 μm; and (c) food grade propylene glycol and polyvinyl alcohol, 6-88 or 6-96, respectively, are utilizable as an alternative plasticizer to glycerol. In an embodiment of the technology, melts are heated to about 180° C.

Another object of the present invention is to disclose an environmentally friendly method of minimizing plastic waste in fields of crops as defined above, wherein the binding materials are free of polyalkenes, including polyethylene.

Another object of the present invention is to disclose an environmentally friendly method of minimizing plastic waste in fields of crops as defined above, wherein the binding material is a water-based dispersion and at last one of the following is held true: (a) viscosity ranges between 1,040 cP at 25° C. and 121 cP at 60° C. utilizing Brookfield DV2T; (b) shear strength ranges between 0.7 to 2.7 MPa according to modified ASTM D 905-03 where thin layer of the dispersions applied on 0.7×0.7-inch area of a wooden veneer with dimensions of 150×2×1.5 mm; after open time of 5 to 20 min, the samples were glued, subjected to the static pressure of 3.5 atm for 3 min and allowed to cure at ambient conditions for at least 48 hours or till constant weight; at least 6 cured assemblies were then tested for shear strength at 5 mm/min speed; and (c) tensile stress at maximum load ranges between 0.3 to 0.5 MPa and Work from preload (toughness) of 200 to 600 N/mm, according modified ASTM D 638-02a, at 50 mm/min speed where the dispersions casted into hand-made rectangular patterns of 1.5×2.0 cm thickness and lateral dimensions of 2×15 cm trays and dried at 25° C. and 30% humidity in the climate chamber for at least 6 days

Another object of the present invention is to disclose an environmentally friendly method of minimizing plastic waste in fields of crops as defined above, wherein the binding material is a hot-melt and at last one of the following is held true: (a) Tensile stress at maximum load ranges between 1.5 to 2.5 MPa; and (b) Work from preload (toughness) ranges between 200 to 2100 N/mm.

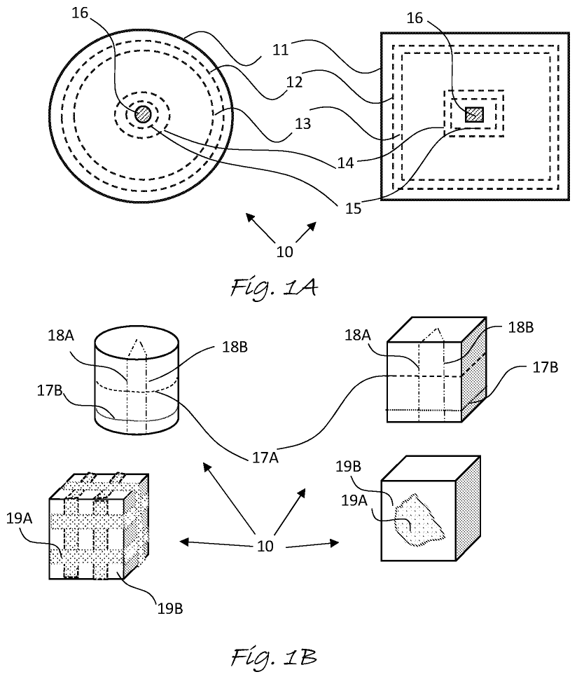

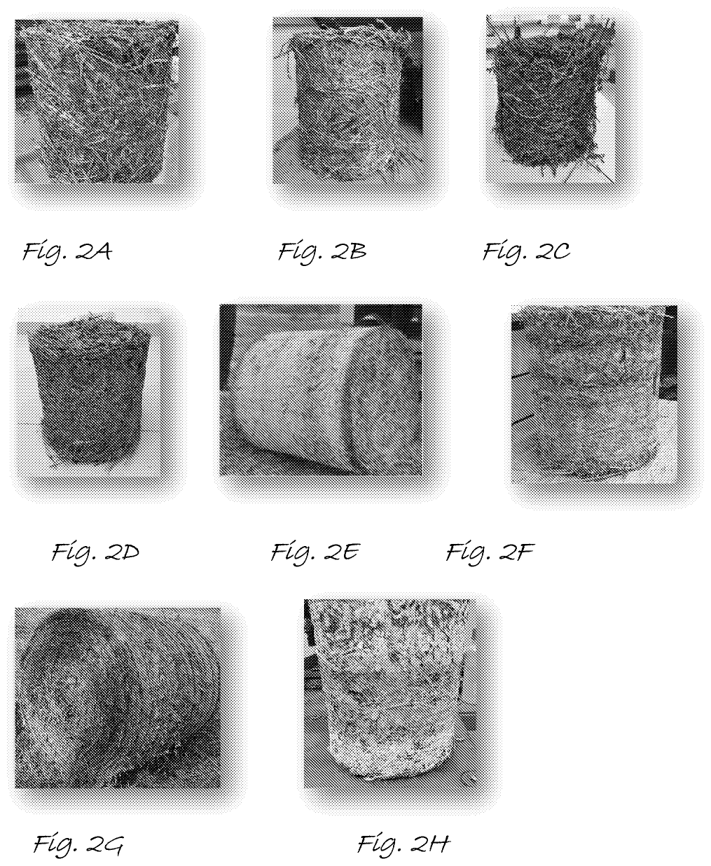

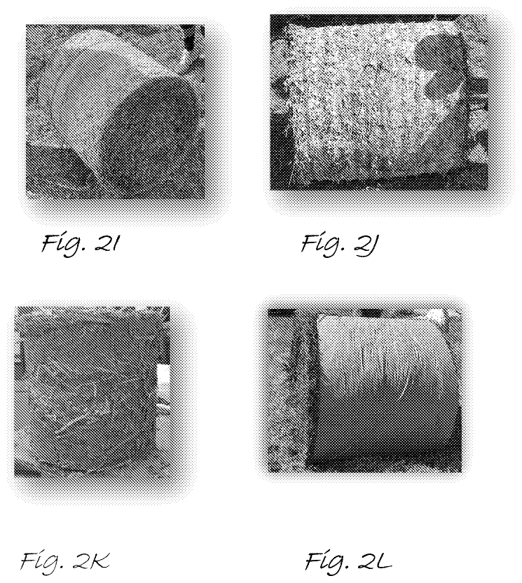

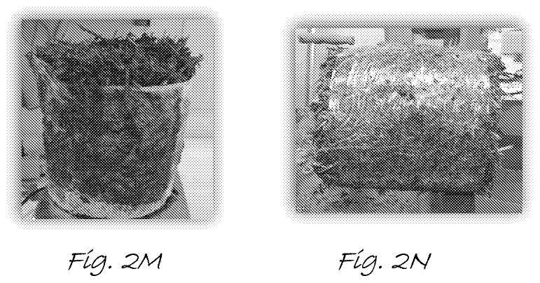

Another object of the present invention is to disclose an environmentally friendly package as defined in any of the above, wherein the binding material is provided in one or more heterogeneous manners as disclosed above, and as examples of which are schematically depicted in FIGS. 1A and B. Such packaging may also promote animal health by limiting if not eliminating plastic contained in the packaged mass, which may be a crop which has been raked, harvested, or the like.

Another object of the present invention is to disclose supporting material for baling a mass of crops. The supporting material characterized by one or more of the following: made of or consists paper and products thereof; made of or consists edible materials, made of or consists food grade materials and/or food contact materials; made of or consists plastic-free binding material comprising less than 0.3 gr and 2.4 gr HDPE and LLDPE per ton silage, respectively; either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from 10 to 1,500 μm; (a)/(b) weight ratio ranging from 100:40 to 0.5:10; thermoplasticized natural polymers are utilized, the natural polymers may include lignocellulosic materials and derivatives thereof; and any derivative, mixture and combination thereof

Still another object of the present invention is to disclose a bale of a mass of crops enveloped or otherwise supported by one or more supporting material administered in homogeneous or heterogeneous manner around or adjacent an external layer of the mass. The supporting material is configured to bond with the mass, wherein the supporting material is selected from one or more members of a group consisting of paper and products thereof; edible materials, food grade materials and/or food contact materials. a plastic-free binding material comprising less than 0.3 gr and 2.4 gr HDPE and LLDPE per ton silage, respectively; either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from 10 to 1,500 μm; (a)/(b) weight ratio ranging from 100:40 to 0.5:10; thermoplasticized natural polymers are utilized, the natural polymers may include lignocellulosic materials and derivatives thereof; and any derivative, mixture and combination thereof.

Another object of the present invention is to disclose a baler comprising a mass compacting module; and a module for administering or otherwise enveloping, wrapping or applying a supporting material either in homogeneous or heterogeneous manner in connection with, around or adjacent to an external portion or layer of the mass.

### DETAILED DESCRIPTION OF THE PREFERRED EMBODIMENTS

In some embodiments, the present disclosure provides a composition for the binding of a mass into a bale. The baled mass may be a crop, such as, for example, hay, salt marsh hay, silage, grass, alfalfa, straw, such as flax straw, corn straw or wheat straw, cotton, or the like, or combinations thereof (any and all of which generally referred to herein as a “crop”). These types of crops are commonly referred to as crops that are cut and raked, where “rake” is a term well known in the art and generally comprises the totality of a harvested crop, and may include leaves, stems, fruits, roots, portions, or any mixture thereof. As noted herein, such crops are usually cut, allowed to dry in the field, and are then subsequently collected, or raked, and baled for storage or transport. The composition of the binding material may provide a number of benefits to the baled mass. For example, the binding material may prevent or minimize the formation of mold, which can prevent crop loss due to rot and mold. In another example, the binding material may be edible or otherwise able to be safely incorporated into animal feed. Such a binding material may thus promote animal health. In still another example, the binding material may be used to form a durable binding of crop bales, such that the bales of crop can remain intact during handling and storage, further preventing or minimizing crop loss.

In some embodiments of the methods presented throughout the present disclosure, including in the following examples section, such methods involve the application of a binding material, which may be a single material or a mixture of one or more materials, to a crop, by mixing the binding material into the crop, or application of the binding material to the outer layer(s) of the crop. In some embodiments, the binding material is applied to the crop as a dry powder, after wetting the crop (unless the crop is already wet or has sufficient humidity), and/or in the form of an aqueous solution, and/or in some examples, as an emulsion. For example, straw may be wetted prior to application of the dry powder. In another example, silage and hay may be treated by an aqueous solution or an emulsion without a need of preliminary wetting, and optionally, further, a powder can be applied on top of the aqueous solution or emulsion.

In some embodiments herein, the components of the binding material can be food additives, edible chemicals or otherwise materials that may be considered safe for animal feed and/or safe for use in an agricultural or food production setting. Additionally, or alternatively, in some embodiments, the component(s) of the binding material are regarded as environmentally friendly, biocompatible, safe or otherwise non-toxic or non-irritant to animals and/or human operators or handlers. Additionally, or alternatively, the binding materials can be regarded as non-toxic to animal and/or plant environments. Hence, for example, the binding material is casein-free (e.g., it does not include sodium caseinate), thus avoiding casein-related allergy, skin issues like acne, rashes, and redness or irritation, and gastrointestinal disorders due to A₁/A₂ type bovine β-casein.

Food Contact Materials (FCM)/Substances (FCS) are materials that either intended to be brought into contact with food, are already in contact with food, or can reasonably be brought into contact with food or transfer their constituents to the food under normal or foreseeable use (FCM, European terminology); and a material is either safe for human consumption or it is okay to come into direct contact with food products (FCS, FDA terminology). Both terms are interchangeably defined hereinafter according to Regulation (EC) No 1935/2004 as materials that do not release their constituents into food at levels harmful to human health; and not change food composition, taste and odor in an unacceptable way.

The term “lignocellulosic materials” refers in a non-limiting manner to cellulose, hemicellulose and lignin and any derivatives, mixtures and types thereof, the term also refer to the definitions and characterizations as disclosed in Hon, David N-S., ed. Chemical modification of lignocellulosic materials. CRC Press, 1995, see e.g., p. 4.

The terms “bale” and “package” are terms well known to the art and interchangeably refer hereinafter to a package of a mass with various dimensions, including small and large; rectangular, round (e.g., cylindrical, rolled) or otherwise shaped package, and typically and as used within this present disclosure, the term refers, in some embodiments, to an agrotechnical-mass, where such a mass refers to a mass of crops, where any of which are ready for baling. A bale of crop, or a baled crop, can then be stored, transported, and/or used. The term “baler” is a term well known in the art and refers to a packaging or baling mechanism, such as commercially available or new future balers, which are a piece of farm machinery utilizable to compress and bind a harvested crop into compact bales that are easy to handle, transport, and store. Within the present disclosure, in some embodiments, the baler is configured to compress the crop into an effectively compressed package, without further binding of same as known in the art using wrap, netting, or the like, but instead is configured to utilize and administer the binding material to bind the baled crop.

The term ‘administering’ refers hereinafter, for example, sprinkling, dripping, wetting, socking, spraying, dousing, dampening, applying a metered dose or otherwise dosing or batching a material being in various states, e.g., gas, liquids, solids or combination thereof. Gas is either in hot (water steams, dry steam etc.) or cold (e.g., ambient) temperature. Liquids are for example waterborne solutions, suspensions, aggregates-containing fluids, water-immiscible, emulsions (e.g., w/o, o/w, w/o/w etc.), homogeneous or heteronomous solutions etc. The solids are e.g., flowable fine particles and particulate matter. A combination of various materials at various phases is further utilizable in a few embodiments of the present disclosure. In some embodiments, the material being administered by any of the above is a binding material.

It is in the scope of the invention wherein the term “administering” refers to a method selected from one or more members of a group consisting of sprinkling, dripping, wetting, socking, spraying, dusting, tampon-printing, dousing, dampening, applying a metered dose or otherwise dosing or batching fluid or fluids being in various states, e.g., gas, liquids, solids, flowable fine particles and particulate matter or combination thereof.

It is according to one embodiment of the invention wherein “administering” is provided (i) in a continuous manner, (ii) pulsed-wise, (iii) in a series of steps, (iv) a plurality of steps, at least one first step is provided in parallel to at least one second step, and any combination thereof. Additionally, or alternatively, the term “administering” is provided by a plurality of steps, at least one first step of providing a mass with a dose (e.g., a predefined weight or volume) of pre-wetted (dry or semi-dry) binding materials is solid state; and at least one second step wetting the hereto solids-administrated mass by a dose of fluid. Additionally, or alternatively, the term “administering” is defining a plurality of steps, at least one first step of providing a mass with pre-wetted (dry or semi-dry) solid binding materials; and at least one second step of wetting the mass and solid binders by a fluid. The first and second steps are provided at separate locations and/or separate time. In this way, e.g., solid mass is administered in the field, and then wetted in the bailer. Alternatively, or additionally, e.g., solid mass is administered in a first portion of the bailer, then wetted in a second portion of the bailer. Alternatively or additionally, mass is administered by a fluid binder in a first location, and then dusted by solid-phase binders in a second location. Alternatively or additionally, mass is administered by a first fluid binder in a first location, and then administered by a second fluid binder in a second location. Alternatively or additionally, mass is administered by a first fluid binder, and then, after a predefined time, the mass is administered again by a second fluid binder. Alternatively, or additionally, e.g., solid mass is administered in a first portion of the bailer, then wetted in a second portion of the bailer. Alternatively, or additionally, e.g., one or more steps of rewetting and/or re-dusting baled-mass with fluids, e.g., fluids with e.g., additives, binding materials, curing agents or the such are provided along a predefined period of time.

Reference is now made to FIG. 1A, schematically illustrating in an out of scale manner two exemplary embodiments of the present disclosure as a lateral cross section, one of a rounded bale (10, left image) and another of a rectangular bale (10, right image). Each bale is characterized by outer surface 11 and inner core 16. The external portion may be schematically divided to a most external portion (layer 11), an inner portion (layer 12) and further layers (13) located inwardly in respect to layer 12. As to round bale 10, these layers may be thought of as concentric, cylindrical layers within the bale. Similarly, inner core 16 is enveloped or otherwise surrounded by external portion (layer 15) which is enveloped or otherwise surrounded by further similar layers located outwardly (14). It is hence in the scope of the invention wherein the concentration of the binding material in the outer portions C^{layer n} is higher than in the inner portions C^{(layer n-1)}. In other words, the concentration of the binding material in the external surface 11 is higher than internal portions, such as layer 15, which may result in a concentration gradient through the bale 10. Rectangular bale 10 is illustrated as having similar layers, which may be square cross-sections, three-dimensional cubic shapes, or rectangular cross-sections through bale 10.

Reference is now made to FIG. 1B, schematically illustrating in an out of scale manner four exemplary embodiments of the invention each of which depicts a perspective view of a bale 10. Upper rounded (left) and rectangular (right) bales are characterized by an equator (line 17A). In this sense, the equator of a rotating spheroid is the parallel, circle of latitude, at which latitude is defined to be 0°. Latitude 17B is located off-center. Lines 18A and 18B define longitudes. It is hence also in the scope of one embodiment of the invention wherein the concentration of the binding material in the central portions (i.e., adjacent to line 17A) is higher than in the remote portions such as those adjacent to line 17B). It is further in the scope of another embodiment of the invention wherein the concentration of the binding material in the central portions (i.e., adjacent to line 17A) is lower than or the same as in the remote portions such as those adjacent to line 17B). It is in the scope of another embodiment of the invention wherein the concentration of the binding material in the central portions (i.e., adjacent to line 17A) and external portions, e.g., layer 12 along longitudes 18a or 18b, is higher than, lower than, or the same as in the inner portions 15 of the same longitudes.

Reference is still made to FIG. 1B, schematically illustrating in an out of scale manner two rectangular bales (lower image on the right and on the left). On the right and lower image, one frontal facet 19B of the external surface of the bale is shown. In a substantially central portion 19A of the facet 19B, and according to yet another embodiment of the invention, the concentration of the binding material is higher in central portion 19A than in other portions of facet 19B. On the left and lower image, the binding material is administrated as one or more strips (19A) where the concentration of the binding material is higher than other portions of the facet (19B). Such strips 19A can be at least one horizontal strip and/or at least one vertical strip to form strips. Of course, diagonal, sinusoidal, “bullseye,” and other strips of different shape and/or orientation are also envisioned. Concentration of binding material along the one or more strips may be consistent or may vary between each strip and/or along the length/width of a strip.

In one set of embodiments of the present disclosure, the administrated compositions are to be provided in any effective dose desired, e.g., between 0.01 to 0.1 percent (%, wt/wt), e.g., 0.015%; between 0.1 percent to 1 percent, e.g., about 0.5%; 1% or more; between 2 to 10 percent, e.g., about 3, 4, 5, or 6%; between about 8 to about 21 percent, e.g., 15%; between about 16 to about 23 percent, e.g., about 20%; 23 percent or more. While these proposed dosages are certain examples, the present disclosure would allow for any other range or particular dosage desired, dependent upon the type of mass being baled, the amount of mass being baled, the type of binding material used, and the layer(s) within the baled mass that the binding material is to be included.

Generally, the present disclosure concerns a binding material, and the formulation, manufacturing, administration and use of same. Throughout the present disclosure, other terms may also be used to generally refer to a binding material, including an adhesive, bind, binder, bound, glued, glue, edible binding material, material allowed for animal feed, and derivatives thereof are interchangeably referring to any substance that is capable of holding materials, such as a mass of crops, together to resist separation of the mass. The binding material may include one or more compositions, many of which are disclosed herein, any or all of which may be used individually or in combination with any other composition. In some embodiments, the binding material may include cements, mucilage, naturally or synthetically produced binders, glues, adhesives, pastes and other applicable terms that are used for any organic material, which may be edible and/or biocompatible and/or can be used with animal feed and/or food packaging that maintains or resists separation of such organic material, animal feed or food.

In some embodiments, the binding material can include non-reactive binders, e.g., those that harden by drying, which in turn can be solvent-based adhesives, water-based systems and polymer dispersion adhesives (emulsion adhesives), e.g., white glue, contact adhesives and rubber cements, polyvinyl acetate-based cements, or the like.

In some embodiments, the binding material may include pressure-sensitive adhesives (PSA) that form a bond by the application of light pressure to marry the adhesive with itself and/or the adhered mass. Pressure-sensitive adhesives may be either solid or within a liquid carrier, subjected to heating or radiation for cross-linking initiation. PSA include for example, acrylate-based polymers, rubber-based, etc., in the presence of a suitable tackifier if needed.

In some embodiments, PSAs are elastomers with a suitable tackifier, e.g., a rosin ester. The elastomers can be based on acrylics; bio-based acrylates, such as butyl rubber, ethylene-vinyl acetate; it may be formulated as a hot-melt PSA, natural rubber, nitriles, silicone rubbers, requiring special tackifiers based on “MQ” silicate resins, composed of a monofunctional trimethyl silane (“M”) reacted with quadra-functional silicon tetrachloride (“Q”). PSAs can alternatively or additionally be selected from styrene block copolymers (SBC), i.e., styrene copolymer adhesives and rubber-based adhesives, that have good low-temperature flexibility, high elongation, and high heat resistance. Those PSAs may be used, for example, in hot melt adhesive applications, where the composition retains tack even when solidified. Additionally, or alternatively, non-pressure-sensitive formulations may also be in use. PSAs may bear an A-B-A structure, with an elastic rubber segment between two rigid plastic endblocks, e.g., resins associating with endblocks, e.g., cumarone-indene, α-methyl styrene, vinyl toluene, aromatic hydrocarbons, etc. Resins associating to the midblocks are e.g., aliphatic olefins, rosin esters, polyterpenes, terpene are also utilizable. Addition of plasticizers reduces cost, improves pressure-sensitive tack, decreases melt viscosity, decreases hardness, and improve low-temperature flexibility. The A-B-A structure promotes a phase separation of the polymer, binding together the endblocks, with the central elastic parts acting as cross-links.

In some embodiments, the binding material may include other adhesives, such as contact adhesives, solvent-based or water-based, such as natural rubber and polychloroprene (Neoprene). Alternatively, or in addition, hot-melt adhesives, such as ethylene-vinyl acetate-based, polyolefin resins, polyamide, polyester resins and other hot-melts are thermoplastics applied in molten form (in the range of −40° C. to 288° C.) which solidify on cooling to form strong bonds between a wide range of materials.

In some embodiments, the binding material may include chemically reactive binders, such as anaerobic adhesives that cure when in contact with metal, in the absence of oxygen; multi-part or multi-component adhesives (MCAs), in some cases—pre-mixed and frozen, generally harden by mixing two or more components which chemically react and cross-link into acrylics, urethanes and epoxy-based adhesives. In this general field of solvent-based or solvent-less MCAs, such combinations as polyester-polyurethane resins, polyols-polyurethane resins, acrylic polymers-polyurethane resins are applicable examples.

In some embodiments, the binding material may include one-part adhesives that harden via a chemical reaction with an external energy source, such as radiation in the presence or absence of free radical or cationic photo-initiator, electronic beam, heat, and moisture. For example, acrylic-based and epoxy-based ultra-violet (UV) light curing adhesives, also known as light curing materials (LCM) are applicable. Heat curing adhesives consist of a pre-made mixture of two or more components, e.g., adhesives that include thermoset epoxies, urethanes, and polyimides. Moisture curing adhesives cure when they react with moisture present on the substrate surface or in the air and include e.g., cyanoacrylates, silicones, polyurethanes, polysulfides, one-container type epoxy and urethanes.

In some embodiments, the binding material may include natural, semi-synthetic and/or synthetic binders. For example, natural binders are made from organic sources (bio-adhesives) such as vegetables (e.g., starch, dextrin, natural rubber, soybean proteins and vegetable oils), crude oil fractions (asphalt and bitumen), or animals (e.g. the milk protein casein, hide-based animal glues, shellac and chitosan). Starch-based adhesives, casein glue, animal glues derived from collagen hydrolysis, albumen made glues, wood lignin and starch are provided herein as examples. Natural adhesives may apply also for inorganic adhesives such as sodium silicate, phosphate and other cements. Semi-synthetic binders refer, for example, to the cellulosic materials subjected to chemical derivatization to form either water or solvent soluble ethers and esters. To this end, representative examples of semi-synthetic adhesives are nitrate, acetate, butyrate, alkyl and carboxyalkyl cellulose. Synthetic binders are also possible for inclusion as a binding material. Those adhesives are based on elastomers, thermoplastics, thermosets and alloys. Elastomers are presented by, but not limited to one-part polyurethane, polyisobutylene, nitrile rubber, styrene-butadiene rubber, polysulfide, silicone and chloroprene. Examples of thermosetting adhesives are provided herein in a non-limiting manner, e.g., epoxy, polyurethane, melamine-, phenol-, urea- or resorcinol-formaldehyde, polyesters, silicones, furans, soluble nylons, polyaromatics and acrylic polymers. Thermoplastic resin adhesives of a synthetic origin include, in a non-limiting manner, polyvinyl esters, acetals, alcohols, alkyl ethers, polystyrene, acrylics, cyanoacrylates, polyamide, polycarbonates, polyacetals, polyethylene and polypropylene and polysulfide. Alloys belong to the named family of synthetic adhesives and are presented by vinyl-, epoxy-, nitrile-phenolics, nylon-, elastomer-, neoprene- and polysulfide-epoxies.

In some embodiments the binding material may include one or more additives including, for example, pharmaceutically acceptable excipients, adjuvants, carriers, antioxidants, preservatives, buffers, biocides, nutrients, minerals, photo-initiators; pigments, dyes, colorants, magnetic substances, leveling agents; wetting agents; adhesion promoters; dispersion aids; anti-blocking agents; anti-caking agents; binders; curing agents; deaerators; diluents; dryers; emulsifiers; fillers; flatting agents; flow control agents; gloss agents; hardeners; lubricants; plasticizers; solvents; stabilizers; surfactants; viscosity modifiers; UV stabilizers; UV absorbers; water repellants, and the like. In some embodiments, the binding material may include stabilizing or enforcing elements, such as ropes, cords, nets, wrappers such as enveloping polymeric sheets, stampers, bands, and the like, though in some embodiments it is the intention to eliminate such physical restraining materials and instead utilize other compositions to restrain the mass, such as baled crops.

The term ‘about’ refers to a value being from 25% less than the defined measure up to 25% more than the defined measure. Similarly, the term “substantially” refers to a value being nearly exact, for instance, accounting for manufacturing tolerances or a value which can be reasonably considered equal to the stated value.

As used in the specification and the appended claims, the singular forms “a,” “an” and “the” include their plural referents unless the context clearly dictates otherwise. For example, reference a “polymer,” a “member” or an “additive” is intended to include the processing or making of a plurality of polymers, members or additives. References to a composition containing or including “an” ingredient or “a” polymer is intended to include other ingredients or other polymers, respectively, in addition to the one named.

It is also understood that the mention of one or more method steps does not preclude the presence of additional method steps before or after the combined recited steps or intervening method steps between those steps expressly identified. Moreover, the lettering of process steps or ingredients is a convenient means for identifying discrete activities or ingredients and the recited lettering can be arranged in any sequence, unless otherwise indicated.

In one embodiment of the present disclosure, a binding material can be used for baling a mass, such as a mass of crops. For example, a binding material is applied on round bales of alfalfa silage, e.g., from about 40 to about 60% (wt/wt) humidity or hay (<40% of humidity). The amount of binding material for use relative to this type of crop may be about 0.05 to about 5%, e.g., 0.15 to 0.25% of the glue for a 800 kg round bale as a sprayable solution or emulsion of varying viscosity, or as a solid form (e.g., powder). In one embodiment, for example, the binding material includes lignin as a major carrier resin which is subjected to the reaction with silane cross-linkers in the presence of plasticizer and can be optionally treated by UV radiation with or without photo-initiator. In another embodiment, for example, the binding material includes a lignin emulsion as a major carrier and lignocellulose, cellulose or tannin fibers which infer improved mechanical properties to the lignin adhesive. These components may be added together prior to application or can be applied sequentially (e.g., the lignin emulsion is applied first followed by the lignocellulose, cellulose or tannin fibers in powder form).

In some embodiments, the binding material may include supporting, stabilizing and/or enforcing elements, such as nets and webs. Those webs are selected, in a non-limiting manner from plastic-free material comprising less than 0.3 gr and 2.4 gr HDPE and LLDPE per ton silage, respectively. Edible materials, e.g., those of Example XVI are utilizable in those supporting webs.

Examples of certain embodiments of the present disclosure will be described more fully below. The following examples and formulations of various exemplary binding materials and uses thereof may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art.

### Exemplary Formulation I—Water-Borne Lignin-Based Adhesive

In one embodiment, the binding material is a lignin-based adhesion formulation utilizable for baling. Lignin is widely used as an adhesive material of natural origin for wood, being a class of complex organic polymers, which may comprise various combinations of monolignols: paracoumaryl alcohol, coniferyl alcohol, and sinapyl alcohol. Its reaction with activated silane cross-linking agent towards Si—O bond formation occurs spontaneously upon mixing and spraying at ambient conditions during the baling process. Polyvinyl alcohol of different grades of hydrolysis can be used as a plasticizer in the named adhesives, while polyvinyl alcohol of 95% of hydrolysis provides the best binding in the lignin-silane composition and is therefore the most preferable one. Final mucilage dries even faster under UV radiation, and can be further fortified by polymerization of the silane unsaturation. Exemplary studies of this adhesive formulation disclosed below determined this formulation can be useful for baling crops. Where listed below, the percent compositions are based on solid ingredients by weight in the final formulation, while water complements the rest.

Materials: 28 to 66% lignin, as calcium lignosulfonate (LIGNOBOND DD, Norway); 1 to 1.7% PVOH 5-74, 47-88 or 4-95 (Kuraray, (Japan)); 0.22 to 0.45% vinyl-trimethoxy-silane (Chongqing Chemdad Co., Ltd (China)); and 3-glycidoxypropyltrimethoxysilane (Chongqing Chemdad Co. Ltd (China)). Those compositions are defined in their final form and are sprayable homogeneous solutions, which are applicable by spraying throughout all the layers of a bale or on some portion of the bale, such as the outer quarter of the baled material, or on the external layer of the baled material (spraying only the outer layer may be beneficial for baling hay or silage). The preferable amount of coating should be between about 1.17% and about 1.95% by weight related to the overall weight of the bale.

### Example I Using Formulation I

The following example provides an embodiment of the present disclosure wherein compositions comprising lignin, vinyl-trimethoxy-silane and polyvinyl alcohol, administered about a 1.6 Kg bale are used. More specifically, about 1600 g of silage were baled into a round bale by a small baler model. About 1200 g were fed without any adhesive addition, whilst about 400 g were sprayed evenly by about 25 g of the adhesive comprised of the ingredients as follows.

Reference is now made to FIG. 2A, presenting a 1600 g round bale of silage bound by lignin, vinyltrimethoxysilane and PVOH as admixed per the below Solution A and Solution B according to this Example 1.

Solution A was prepared by dissolution of about 22 g of lignin dissolved in about 17.3 g water. About 6.3 g of PVOH (4-95, by Kuraray, Japan) as about 10% wt water solution were added to the lignin solution.

Solution B was prepared by dispersing about 0.4 g vinyl-silane in about 20 g of 1:1 iso-propyl alcohol/H₂O solution ratio and addition of about 0.06 g of glacial acetic acid, till pH equals 3. About 3 g of Solution B were admixed to Solution A. About 25 g of the obtained formulation were spread on the last about 400 g of the silage to afford very good binding and stable bale (FIG. 2A).

### Example II Using Formulation I

The following example provides an embodiment of the present disclosure wherein compositions comprising lignin and vinyl-trimethoxy-silane, about an 1.8 Kg bale are utilized. About 1800 g of silage were baled into a round bale by a small baler model. About 1400 g were fed without any adhesive addition, whilst about 400 g were sprayed evenly by about 30 g of the adhesive comprised of the ingredients as follows.

Reference is now made to FIG. 2B, showing a 1.8 Kg of round bale of silage bound by lignin and vinyl-trimethoxy-silane as prepared per the below Solution A and Solution B, according to this Example 2.

Solution A was prepared by dissolution of about 20 g of lignin dissolved in 12 g water.

Solution B was prepared by dispersing 0.4 g vinyl-trimethoxy-silane in 20 g of iso-propyl alcohol/H₂O solution (1:1) and addition of 0.06 g of citric acid, till reaching pH=3.5. 5.75 g of Solution B were added to Solution A. 30 g of the obtained formulation were spread on the last 400 g of the silage, which was found to afford excellent binding and a stable bale (FIG. 2B).

### Example III Using Formulation I

The following example provides an embodiment of the present disclosure wherein compositions comprising lignin, 3-glycidoxy-propyl-trimethoxy-silane and polyvinyl alcohol, were administered to an 1.8 Kg bale. 1800 g of silage were baled into a round bale by a small baler model. 1400 g were fed without any adhesive addition, whilst 400 g were sprayed evenly by 30 g of the adhesive comprised of the ingredients as follows.

Reference is now made to FIG. 3, showing 1.8 Kg of round bale of silage bound by lignin, 3-glycidoxy-propyl-trimethoxy-silane and PVOH as prepared per the below Solution A and Solution B, according to this Example 3.

Solution A was prepared by dissolution of 22 g of lignin dissolved in 17.3 g water. 6.3 g of PVOH (4-95, Kuraray) as 10% wt water solution were added to the lignin solution.

Solution B was prepared by dispersing 0.4 g 3-glycidoxy-propyl-trimethoxy-silane in 20 g of iso-propyl alcohol/H₂O solution (1:1) and addition of 0.06 g of acetic acid, till reaching pH=3.5-4. 5.7 g of Solution B were added to Solution A. 30 g of the obtained formulation were spread on the last 400 g of the silage to afford good binding and stable bale (FIG. 2C).

### Exemplary Formulation II—Water-Borne Wood Fiber/Lignocellulose Enriched Lignin-Based Adhesive

In another embodiment, the binding material is a calcium lignosulfonate solution or lignosulfonate/PVOH emulsion as a major carrier, while particulate matter of a wood fiber/lignocellulose origin is used to fortify the obtained mucilage and to confer it a mechanical stability. In particular, wood fiber/lignocellulose, commercially available as Lignocel trademark, a product by J. Rettenmaier & Söhne GmbH (JRS, Germany) (hereinafter “Lignocel”) of different particles size (JRS) or even powdered lignin can be applied on top of the lignin emulsion sprayed over the external layers of the round bale. Addition of plasticizer such as glycerol or propylene glycol improves the mechanical properties of the lignin solution in relation to stress exerted on the bale. To reach an even more rigid mucilage, a combination of lignin and partially hydrolyzed PVOH furnishes a viscous emulsion which can be alternatively enriched by glycerol or propylene glycol to affect the viscosity and Young modulus. The obtained emulsion is applied by dripping and further fortified by powder application to furnish highly stable bale. Calcium oxide serves a good alternative to wood fibers when applied along with a lignin solution or lignin/PVOH emulsion, with or without a plasticizer. A recommended composition is presented below by weight percent of the solids in the final formulation, the remainder being primarily water.

The composition comprises 43% to 71% lignin (as calcium sulfonate, LIGNOBOND DD) and 6.8 to 11.36% Lignocel wood fiber/lignocellulose powder (soft wood such as BK 40-90, Arbocel HS250, CW 630 PU, C-320, C-100 or C-750 FP and alike, or hard wood such as HB 4115 and alike—all manufactured by JRS, or powdered lignin) or 12.5 to 21% calcium oxide; or 15 to 25% of lignin and 2.7 to 4.5% of PVOH and 18 to 32% wood fiber/lignocellulose powder. To the total solids of Lignin or Lignin/PVOH blend, 20 to 40% of glycerol propylene glycol can be optionally added. In one example of a use of this exemplary formulation, application on a round bale is provided by spraying of the lignin emulsion on the last ⅕ of the baled material or alternatively on the external layer of hay or silage, followed by homogeneous application of Lignocel or calcium oxide as a powder on the external layer. An application of a viscous emulsion of Lignin/PVOH is implemented by dripping on the external layer, followed by spraying the Lignocel by a powder gun or applicator. The total amount of coating as related to the overall round bale weight is recommended to be in the range of 0.7% to 7.8%.

### Example IV Using Formulation II

The following example provides an embodiment of the present disclosure wherein compositions comprising lignin and Lignocel, were administered to a 1.8 Kg bale according to this Example IV. An 1800 g of silage were baled into a round bale by a small baler model. About 1400 g were fed without any adhesive addition, whilst 400 g were sprayed evenly by 30 g of the Solution A (20 g of lignin dissolved in 12 g water). 3 g of Lignocel were sprayed as a powder on the external layer to furnish excellent binding and a stable bale (FIG. 2D).

### Example V Using Formulation II

The following example provides an embodiment of the present disclosure wherein compositions comprising lignin and Lignocel™, were administered to a 43 kg bale prepared by a small field baler according to this Example V (see FIG. 2O). At the completion of the baling process, Solution A (468.6 g of lignin dissolved in 356.4 g water) was evenly applied on the external bale layer by spraying guns. 400 g of commercially available Arbocel CW630PU (JRS, raw cellulose, 20 to 40 μm) were sprayed as a powder on top of the lignin solution to furnish excellent binding and a stable bale (FIG. 2E).

### Example VI Using Formulation II

The following example provides an embodiment of the present disclosure wherein compositions comprising lignin/PVOH and Arbocel, administered to a 2.7 Kg bale prepared by a small lab baler according to this Example VI. At the completion of the baling process, 90 g of viscous emulsion (made of 220 g of lignin, 39.96 g of PVOH 47-88 and 563.04 g water) were evenly applied on the external bale layer by a dripping applicator. 30 g of commercially available Arbocel C-320 (JRS, raw cubic cellulose (200-500 μm) were manually sprayed as a powder on top of the lignin/PVOH emulsion to furnish excellent binding and a rigid bale (FIG. 2F).

### Example VII Using Formulation II

The following example provides an embodiment of the present disclosure wherein compositions comprising lignin/PVOH and Arbocel, administered to a 50 kg bale prepared by a small field baler according to this Example VII. At the completion of the baling process, 1944 g of viscous emulsion (made of 656 g of lignin, 219 g of PVOH 6-88 and 1,069 g water) were evenly applied on the external bale layer by a dripping applicator. 1,160 g of commercially available Arbocel C CW630PU (JRS, raw cellulose, 20 to 40 μm) were manually sprayed as a powder on top of the lignin/PVOH emulsion to furnish excellent binding and a rigid bale (FIG. 2G).

### Example VIII Using Formulation II

The following example provides an embodiment of the present disclosure wherein compositions comprising lignin and calcium oxide were administered to 2.7 Kg bale according to this Example VIII. At the completion of the baling process, an external layer was sprayed evenly by 20 g of the Solution A (12.5 g of lignin dissolved in 7.5 g water). 5 g of calcium oxide were admixed evenly as a powder on the external layer to furnish excellent binding and a stable bale (FIG. 2H).

### Example IX Using Formulation II

The following example provides an embodiment of the present disclosure wherein compositions comprising lignin/glycerol and calcium oxide, was administered to a 52.5 kg bale prepared by a small field baler according to this example. At the completion of the baling process, 488 g of emulsion, made e.g., of 271.3 g of lignin, 54.3 g of glycerol and 162.5 g water, was evenly applied on the external bale layer by spraying guns. 150 g of calcium oxide scattered as powder on the bale surface to afford a tightly adhered and rigid bale (FIG. 2I).

### Example X Using Formulation II

Composition comprising lignin/PVOH/glycerol and calcium oxide was applied on 59 kg bale according to this example. At the completion of the baling process, an external layer was covered evenly by 817 g of the viscous emulsion, e.g., made of 337.5 g of lignin, 67.5 g of PVOH, 81.11 g of glycerol and 330.9 g water, by means of dripping. 150 g of calcium oxide were applied evenly as a powder on the external layer to furnish excellent binding and a stable bale (FIG. 2J).

### Exemplary Formulation III—Water-Free Thermoplastic Hot-Melt Lignin-Based Adhesive

In another embodiment, a water-free blend comprised of calcium lignosulfonate as a major carrier, glycerol or propylene glycol and soft or hard wood particulate matter, furnishes a thermoplastic hot-melt adhesive. In particular, pure cellulose UFC-100, commercially available as Lignocel trademark product by J. Rettenmaier & Söhne GmbH (JRS, Germany) confers the blend excellent mechanical properties. Other soft and hard wood powders of different particles size or calcium oxide can be used as well. Addition of paraffin wax as a viscosity, fluidity and wettability regulator, along with fumed hydrophilic silica as an anti-sagging agent affords a hot-melt composition with desired mechanical and physical properties. The formulations are compounded by an overhead stirrer, then homogenized by a lab-scale roll-mill heated to 80° C. Upon melting completion, the blend is scraped and cooled to afford pellets which can be further applied by a heated spraying gun on the bale surface. The composition comprises about 52% to about 82% lignin (as calcium sulfonate, LIGNOBOND DD), about 21% to about 33% glycerol or propylene glycol, 5 about.2% to about 8.13% pure cellulose powder (or soft wood such as BK 40-90, Arbocel HS250, CW 630 PU, C-320, C-100 or C-750 FP and alike, or hard wood such as HB 4115 and alike, all manufactured by JRS, Germany, or calcium oxide), about 1.6% to about 2.5% paraffin wax and about 0.08% to about 0.125% fumed hydrophilic silica (as Aerosil 200, a commercially available product by Evonik, Germany). The total amount of coating as related to the overall round bale weight is recommended to be in the range of about 1.3% to about 2%.

Lignin is the second most abundant bio-based material found on earth. It is produced mainly as a byproduct of pulp and paper industry and biorefineries. Despite its abundance, lignin valorization is not achieved on a large scale. FORMULATION III enables utilization of lignin as functional and structural component of the thermoplastic polymers which requires structural modifications of lignin pertaining to the polymeric system. As will defined below, water-free thermoplasticized natural polymers are provided useful for controlling the homogeneity, reactivity, processability and compatibility of lignin for successful thermoplastic copolymer synthesis and blend processing.

It is hence another embodiment of the invention wherein a water-free blend comprises e.g., calcium lignosulfonate as a major carrier, glycerol or propylene glycol and soft or hard wood particulate matter, furnishes a thermoplastic hot-melt adhesive. Various thermoplastic bio-polymers are utilizable after modification according to the roles provided hereinabove; some of which provide opportunities to improve mechanical properties, heat and fire resistance, wettability and, for thermoplasticized natural polymers to hinder the plasticizer migration; see for example (1) Parit, Mahesh, and Zhihua Jiang. “Towards lignin derived thermoplastic polymers.” International Journal of Biological Macromolecules (2020). (2) Morais, L. C., et al. “Thermoplastic Starch-Glycerol-Lignosulfonate Blends: Mixtures of Thermally Molded Blends Studied in a Ternary Diagram.” Journal of Thermoplastic Composite Materials 23.5 (2010): 699-716. (3) Oliviero, Maria, et al. “Effect of supramolecular structures on thermoplastic Zein-Lignin bionanocomposites.” Journal of agricultural and food chemistry 59.18 (2011): 10062-10070.

### Example XI Using Formulation III

A hot melt composition comprising lignin/glycerol/cellulose was utilized in a 3 kg bale. At the completion of the baling process, an external layer was applied evenly using a 50 g of hot-melt blend, made of 100 g lignin, 40 g glycerol, 10 g soft-wood pure cellulose UFC-100, 3 g paraffin wax, and 0.2 g Aerosil 200. The application of this external layer was provided by using a spraying gun at 180° C. The blend solidifies immediately on the bale surface, thereby formed a stable external mucilage (FIG. 2K).

It is acknowledged that at least a portion of the pure cellulose powder (here, UFC-100) is replicable by various commercially available wood-based powders and grades thereof, including those that are food grades and those that are allowed to be in with food, with or without CaO or equivalents thereof, preferably, food grade products)

It is also acknowledged that binding materials of the present invention are selectable from fully edible materials, and materials that are allowed to a direct contact with food, such as in food packages. Food grade powders are hence selectable from a group consisting inter alia: cellulose UFC-100 (size ranging from about 8 to about 10 μm), Hard wood cellulose is either one or all BE 600-10-TG (about 18 μm), BE 600-30 (about 30 μm), CaO (about 50 μm), HB 4115 (from about 40 to about 110 μm), and Soft wood fibers is BK 40 90 (about 1,500 μm). Food contact grade powders are selectable from a group consisting inter alia: a soft wood Lignocel Tardemark product, commercially available by J. Rettenmaier & Söhne GmbH+Co KG, DE, either or all CW-630-PU (size ranging from about 20 to about 40 μm), C-750-FP (from about 40 to about 70 μm), C-100 (from about 70 to about 150 μm), C-320 (from about 200 to about 500 μm); and soft wood fibers including HS-250 (from about 150 to about 350 μm). Much similarly, food grade propylene glycol and polyvinyl alcohol (e.g., 6-88 or 6-96 commercially available products for food packaging by KURARAY, Germany) are utilizable as adhesives.

### Example XII

In another embodiment, various silanes were used. Hence for example, the silanes are selected in a non-limiting manner form a group consisting of vinyl-silane iso-propyl alcohol, vinyltrimethoxysilane, glycidoxy-propyl-trimethoxy-silane and any derivative and mixtures thereof.

### Example XIII Physical Properties of Formulations Described in Application 2

Water-based dispersion as defined in EXEMPLARY FORMULATION II has been characterized by its physical properties as follows: as viscosity (utilizing Brookfield DV2T), shear strength, tensile strength at maximum load and toughness (utilizing Instron).

Hot melt as defined in EXEMPLARY FORMULATION III has been tested for tensile strength at maximum load and toughness.

### Methods

Tensile strength Water-based dispersions were cast into hand-made rectangular patterns of 1.5×2.0 cm thickness and lateral dimensions of 2×15 cm trays and dried at 25° C. and 30% humidity in the climate chamber for at least 6 days. Cured samples were then extricated and subjected to tensile testing according to the modified ASTM D 638-02a, at 50 mm/min speed. At least 6 specimens of each composition were tested.

Hot-melt composites were compounded on roll-mill machine at 80° C., scraped and cut into strips of 0.4×2.0 mm and lateral dimensions of 1.5×10 cm, stored in the climate chamber for at least 5 days at 25° C. and 30% humidity. The samples were then subjected to tensile testing at the rate of 50 mm/min. At least 5 specimens of each composition were tested.

Shear strength Shear strength of water-based dispersions were tested according to a modified ASTM D 905-03. A thin layer of water-based dispersions (0.083 g of total solids in all cases) were applied on 0.7×0.7-inch area of the wooden veneers with dimensions of 150×2×1.5 mm. After open time of 5 to 20 min, the samples were glued, subjected to the static pressure of 3.5 atm for 3 min and allowed to cure at ambient conditions for at least 48 hours or till constant weight. At least 6 cured assemblies were then tested for shear strength at 5 mm/min speed.

### Results

Formulation elaborated in Example IX (composed of 271.3 gr of lignin, 54.3 gr of glycerol and 162.5 gr water):

| a. | Viscosity: | 1,040 cP at 25° C. and | |
|---|---|---|---|
| | | 121 cP at 60° C. | |
| b. | Shear strength | 0.7 to 2.7 | MPa |
| c. | Tensile stress at maximum load | 0.3 to 0.5 | MPa |
| d. | Work from preload (toughness) | 200 to 600 | N/mm |

Formulation elaborated in Example X (composed of 337.5 gr of lignin, 67.5 g of PVOH, 81.11 gr of glycerol and 330.9 gr water):

| a. | Viscosity: | 9,250 cP at 25° C. and | |
|---|---|---|---|
| | | 1,283 cP at 60° C., | |
| b. | Shear strength | 0.5 to 3.0 | MPa |
| c. | Tensile stress at maximum load | 0.5 | MPa |
| d. | Work from preload (toughness) | 800 | N/mm |

Formulation elaborated in EXEMPLARY FORMULATION III

Hot-melt formulation elaborated in Example XI (composed 100 g of lignin, 40 g of glycerol, 10 gr of soft-wood pure cellulose UFC-100, 3 gr paraffin wax and 0.2 gr of Aerosil 200)

| Viscosity | solid at room temperature | |
|---|---|---|
| Shear strength | impossible to spread over | |
| | the wooden veneer | |
| Tensile stress at maximum load | 1.5 to 2.5 | MPa |
| Work from preload (toughness) | 200 to 2100 | N/mm |

### Example XIV UV Curing

Some embodiments are provided useful when the binding material may include curing agent in general, and one or some of a group consisting of UV stabilizers; UV absorbers and UV-curing agent(s) in particular.

It is acknowledged that in UV curing, one preferred (but not exclusive) path is cationic curing of epoxide end groups, allowing “dark curing” (post curing after radiation is removed) due to lack of termination reactions. Hence for example, a wide range of cationic UV-curing agents is utilizable see, material and methods described by Noè, Camilla, Minna Hakkarainen, and Marco Sangermano. “Cationic UV-curing of epoxidized biobased resins.” Polymers 13.1 (2021): 89, including the examples depicted in FIGS. 2, 3, 5 and 7. In one of the embodiments of the present invention, the amount of binding material for use relative to this type of crop is ranging from about 0.05 to about 5%, e.g., from 0.15 to 0.25% of the glue for a 800 kg round bale as a sprayable solution or emulsion of varying viscosity, or as a solid form (e.g., powder).

In example IV, the binding material includes lignin as a major carrier resin which is subjected to the reaction with silane cross-linkers in the presence of plasticizer and can be optionally treated by UV radiation with or without photo-initiator. In another embodiment, for example, the binding material includes a lignin emulsion as a major carrier and lignocellulose, cellulose or tannin fibers which infer improved mechanical properties to the lignin adhesive.

### Example XV Binder Made of Spray-Dried Adhesive Pellets

Examples I-X describe an application of water-based binder, comprised of lignosulfonate as major binder, glycerol as a plasticizer, polyvinyl alcohol as a film forming agent. The binder is sprayed or dripped on the external or internal bale layer, followed by Lignocel or CaO powder for water absorption and bale reinforcement. Along with the advantages of this method of application, an alternative approach suggests that the binder is freeze-dried and grinded to 200-800 mm pellets. Then, the dried pellets are sprayed by a spraying gun or powder applicator on the external bale surface or the last ⅕ of the crop layer and rehydrated by the natural moisture in case of silage or by the controlled moisture addition in case of dry crops such as hay and straw. The dehydration of the solid binder recovers its tackiness and binding properties. The recommended range of dry pellets quantity as related to the overall round bale weight is from 0.7% to 3%.

Similarly, water-free thermoplastic hot-melt lignin-based binder, which application is described in Examples XI-XII by means of spraying gun at 180° C., can be grinded to fine particles and applied in solid form on the external bale surface or the last ⅕ of the crop layer by a spraying gun or powder applicator without heating. The composition is made of lignin, glycerol, cellulose, paraffin wax and hydrophilic silica. Its binding properties and tackiness are activated in situ by the natural moisture in case of silage or externally added moisture in the sufficient amount in case of dry crops such as hay and straw. In an embodiment of the invention, useful range of hot-melt dry pellets quantity as related to the overall round bale weight is from 0.7% to 3%.

### Example XVI Edible Packaging

In addition, or as an alternative to the water-based or hot-melt adhesive system, is means and methods of packaging round or square bales into film made of animal (selected e.g., from firm animals, such as cows, goats and pigs, and humans) edible polymers. Those means and methods are not influenced by such factors as crop length or moisture content and allows wrapping any bale regardless stalks length or morphology or moisture.

It is in the scope of the invention wherein either one or both techniques that are used for the preparation of edible films are utilized in this invention: solvent casting (wet technique) and compression molding or extrusion (dry technique). In the former method, dispersion of edible biopolymeric materials is spread over appropriate base material followed by drying and holding for a suitable time for the development of the film.

It also is in the scope of the invention wherein polymers to be used are selected from polysaccharides, proteins, lipids or composites. Polysaccharides, complex carbohydrates, are wildly used in the preparation of edible packaging. Polysaccharides occur naturally in nature and can have different origins: animal (e.g., chitin and chitosan), plant (e.g., starch and pectin), marine (e.g., alginate) and microbial (e.g., xanthan gum and pullulan). Proteins are macromolecules divided into fibrous and globular proteins. Fibrous protein is water-insoluble and has an animal origin, whereas globular proteins are soluble in water, acids and basic solutions and have a plant origin. Different proteins, such as whey protein, casein, gelatin, collagen, soy protein, wheat gluten and corn zein, are used in the preparation of edible food packaging. They can originate films and coatings that are hydrophilic and with good oxygen barriers but poor mechanical strength. Lipids originate from animals, insects or plants, and they are naturally hydrophobic polymers. The most commonly used lipids in edible packaging are natural waxes, acetylated monoglycerides and resins. Lipids can provide films and coatings with good barrier properties to moisture but poor barrier properties against oxygen and carbon dioxide. In addition, lipids originate brittle and thicker films and coatings with poor mechanical properties. To overcome the disadvantages of each polymer, they can be combined to obtain films or coatings with better barrier and mechanical properties. The combination of different polymers results in composite films and coatings. Several combinations can be made, such as polysaccharides and proteins, polysaccharides and lipids, protein and lipids, a combination of two different polysaccharides or the combination of natural and synthetic polymers, among other options. Lipids are frequently added to polysaccharide and protein films and coatings to improve their water barrier properties. Then again, to overcome the poor mechanical properties of lipid polymers, polysaccharides and proteins can also be added. Composite films and coatings are e.g., corn starch and carboxymethyl cellulose, whey protein isolate and zein, starch, gellan and thyme essential oil, chitosan and alginate and others. The weaker mechanical properties of these biopolymers or biocomposites can also be overpassed with the introduction of nanofillers, e.g., montmorillonite or nanocellulose, that reinforce the polymeric structure. Other materials, means and methods are known in the art, see e.g., Chanda Vilas Dhumal, Preetam Sarkar. “Composite edible films and coatings from food-grade biopolymers.” J Food Sci Technol (November 2018) 55(11):4369-4383; and Kouhi, Monireh, Molamma P. Prabhakaran, and Seeram Ramakrishna. “Edible polymers: An insight into its application in food, biomedicine and cosmetics.” Trends in Food Science & Technology 103 (2020): 248-263.

### Example XVII Paper Packaging

Kraft paper or paperboard (cardboard) produced from chemical pulp produced in the Kraft process. In this example, 5×1.23 m, 130 gr/m² Kraft paper sheets were coated with water-based binder comprising calcium lignosulfonate, glycerol, polyvinyl alcohol and microcellulose, fully dried and then used to wrap ca. 800 kg wet Alfalfa into round bale. The amount of full dried binder ranged between 340 to 970 gr. Binding between the crop surface and coated paper was facilitated by water sprinkling, which further activated the dried adhesives making it tacky. A stable 800 kg Alfalfa round silage bale was afforded (FIG. 2L). When 800 kg round silage bale is wrapped with an uncoated Kraft paper, the wrap does not withstand the falling impact and the paper tears off. Thus, the above coating endows the paper an additional elongation and toughness.

### Example XVIII Bamboo Packaging

In this example, 19×71, 45 gr/m² non-woven bamboo fabric was coated with 24 mm emulsion of water-based binder comprising calcium lignosulfonate, glycerol, polyvinyl alcohol and microcellulose, fully dried and then used to wrap 3 kg wet Alfalfa into round bale. Binding between the crop surface and coated bamboo sheet was facilitated by natural crop moisture which induced the glue tackiness, thus forming stable bale (FIG. 2M). Tensile strength of the coated bamboo sheet is in the range of 9-11 MPa.

### Example XIX Polysaccharide Film for Packaging

In this example, 19×71, 45 gr/m² polysaccharide film, e.g., a commercially available Nutrafilm™ by Inox Meccanica S.R.L. (IT) is coated with 24 mm emulsion of water-based binder comprising calcium lignosulfonate, glycerol, polyvinyl alcohol and microcellulose, fully dried and then used to wrap 3 kg wet Alfalfa into round bale. Binding between the crop surface and coated film was facilitated by natural crop moisture which induced the glue tackiness, thus forming stable bale (FIG. 2N). Tensile strength of the uncoated polysaccharide film is in the range of 2 to 3 MPa.

### Example XX A Method of Avoiding Animal's Poisoning

A method of avoiding animal's poisoning by minimizing their consumption of plastic waste is provided useful by utilizing plastic-free binding materials for baling a crop. The plastic-free binding material comprises less than 0.3 gr and 2.4 gr HDPE and LLDPE per ton silage, respectively, for baling the crops.

The method is applicable wherein the binding materials are free of polyalkenes, including polyethylene; and/or wherein biding materials are either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from 10 to 1,500 μm; (a)/(b) weight ratio ranging from 100:40 to 0.5:10.

The method is also applicable wherein biding materials are elected from either or both food grade materials and food contact materials; and/or wherein at least one of the following is held true: food grade biding materials are selected from a group consisting of cellulose is UFC-100, size ranging from 8 to 10 μm; hard wood cellulose is selected from a group consisting of BE 600-10-TG, size ranging from 18 μm, BE 600-30, size ranging from 30 μm, HB 4115, size ranging from 40 to 110 μm; and soft wood fibers BK 40 90, 1,500 μm; food contact materials are selected from a group consisting of soft wood Lignocel selected from a group consisting of CW-630-PU, size ranging from 20 to 40 μm, C-750-FP, size ranging from 40 to 70 μm, C-100, size ranging from 70 to 150 μm, C-320, size ranging from 200 to 500 μm; soft wood fibers HS-250, size ranging from 150 to 350 μm; and food grade propylene glycol and polyvinyl alcohol, 6-88 or 6-96, respectively, are utilizable as an alternative plasticizer to glycerol.

The method is also applicable wherein melts are heated to 180° C.; and/or wherein the binding material is a water-based dispersion and at last one of the following is held true: viscosity ranges between 1,040 cP at 25° C. and 121 cP at 60° C. (Brookfield DV2T); shear strength ranges between 0.7 to 2.7 MPa according to modified ASTM D 905-03 where thin layer of the dispersions applied on 0.7×0.7-inch area of a wooden veneer with dimensions of 150×2×1.5 mm; after open time of 5 to 20 min, the samples were glued, subjected to the static pressure of 3.5 atm for 3 min and allowed to cure at ambient conditions for at least 48 hours or till constant weight; at least 6 cured assemblies were then tested for shear strength at 5 mm/min speed; and Tensile strength was measured according to modified ASTM D 638-02a, at 50 mm/min speed utilizing Instron machine, where the dispersions casted into hand-made rectangular patterns of 1.5×2.0 cm thickness and lateral dimensions of 2×15 cm trays and dried at 25° C. and 30% humidity in the climate chamber for at least 6 days; tensile stress at maximum load ranges between 0.3 to 0.5 MPa and Work from preload (toughness) of 200 to 600 N/mm.

The method is also applicable wherein binding material is a hot-melt and at last one of the following is held true: tensile stress at maximum load ranges between 1.5 to 2.5 MPa; and work from preload (toughness) ranges between 200 to 2100 N/mm.

The method is also applicable wherein thermoplasticized natural polymers are utilized, the natural polymers may include lignocellulosic materials and derivatives thereof.

### Example XXI A Method of Minimizing Plastic Waste in Fields of Crops

A method of minimizing plastic waste in fields of crops was found useful by utilizing plastic-free binding material comprising less than 0.3 gr and 2.4 gr HDPE and LLDPE per ton silage, respectively, for baling the crops.

The method is also applicable wherein biding materials are either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from 10 to 1,500 μm; (a)/(b) weight ratio ranging from 100:40 to 0.5:10.

The method is also applicable wherein biding materials are elected from either or both food grade materials and food contact materials; and/or wherein at least one of the following is held true: food grade biding materials are selected from a group consisting of cellulose is UFC-100, size ranging from 8 to 10 μm; hard wood cellulose is selected from a group consisting of BE 600-10-TG, size ranging from 18 μm, BE 600-30, size ranging from 30 μm, HB 4115, size ranging from 40 to 110 μm; and soft wood fibers BK 40 90, 1,500 μm; food contact materials are selected from a group consisting of soft wood Lignocel selected from a group consisting of CW-630-PU, size ranging from 20 to 40 μm, C-750-FP, size ranging from 40 to 70 μm, C-100, size ranging from 70 to 150 μm, C-320, size ranging from 200 to 500 μm; soft wood fibers HS-250, size ranging from 150 to 350 μm; and food grade propylene glycol and polyvinyl alcohol, 6-88 or 6-96, respectively, are utilizable as an alternative plasticizer to glycerol.

The method is also applicable wherein melts are heated to 180° C., and/or wherein the binding materials are free of polyalkenes, including polyethylene.

The method is also applicable wherein the binding material is a water-based dispersion and at last one of the following is held true: viscosity ranges between 1,040 cP at 25° C. and 121 cP at 60° C. (Brookfield DV2T); shear strength ranges between 0.7 to 2.7 MPa according to modified ASTM D 905-03 where thin layer of the dispersions applied on 0.7×0.7-inch area of a wooden veneer with dimensions of 150×2×1.5 mm; after open time of 5 to 20 min, the samples were glued, subjected to the static pressure of 3.5 atm for 3 min and allowed to cure at ambient conditions for at least 48 hours or till constant weight; at least 6 cured assemblies were then tested for shear strength at 5 mm/min speed; and Tensile strength was measured according to modified ASTM D 638-02a, at 50 mm/min speed utilizing Instron machine, where the dispersions casted into hand-made rectangular patterns of 1.5×2.0 cm thickness and lateral dimensions of 2×15 cm trays and dried at 25° C. and 30% humidity in the climate chamber for at least 6 days; tensile stress at maximum load ranges between 0.3 to 0.5 MPa and Work from preload (toughness) of 200 to 600 N/mm.

The method is also applicable wherein the binding material is a hot-melt and at last one of the following is held true tensile stress at maximum load ranges between 1.5 to 2.5 MPa; and work from preload (toughness) ranges between 200 to 2100 N/mm; and/or wherein thermoplasticized natural polymers are utilized, the natural polymers may include lignocellulosic materials and derivatives thereof.

Although the disclosure herein has been described with reference to particular embodiments and examples, it is to be understood that these embodiments and examples are merely illustrative of the principles and applications of the present disclosure. It is therefore to be understood that numerous modifications may be made to the illustrative embodiments and examples and that other arrangements may be devised without departing from the spirit and scope of the present disclosure as defined by the appended claims.

1.-50. (canceled)

51. A method of binding a mass into a bale, the bale including at least one inner layer and at least one external layer, the method comprising steps of (i), administering a binding material to said mass, and (ii) binding said material with said mass, wherein at least one of the following is true:
a. the concentration (% wt) of said binding material at said at least one (i) external cross-section layer (L) [C^{Li}ₒᵤₜ] is higher than said at least one (j) inner cross-section layer [C^{Lj}ᵢₙ]; i and j are integers each of which is equal to or is greater than 1 and [C^{Li}ₒᵤₜ]>[C^{Lj}ᵢₙ];
b. the concentration (% wt) of said binding material at said external cross-section layers decreases so that [C^{Li=n}ₒᵤₜ]>[C^{Li=(n+1)}ₒᵤₜ], n is an integer equal to or greater than 1, where n increases with each successive layer further from the external surface of the bound mass;
c. the concentration (% wt) of said binding material at the outermost external cross-section layer [Cₒᵤₜ] is higher than at the innermost cross-section layer [Cᵢₙ];
d. the concentration (% wt) of said binding material at the outermost cross-section layer is f times higher than at the innermost cross-section layer, and f≥1.5;
e. the concentration (% wt) of said binding material relative to the bound mass at the outermost cross-section layer is [Cₒᵤₜ]≥0.4%, whilst the concentration of said binding material relative to the bound mass within the innermost cross-section layer is [Cᵢₙ]≤0.2%;
f. said bale characterized by a solid geometry having an equator, wherein concentration (% wt) of said binding material relative to the bound mass at the at least one external cross-section layer along said equator [C^{Eq}ₒᵤₜ] is higher than within the at least one inner cross-section layer (j) [C^{Lj}ₒᵤₜ];
g. concentration (% wt) of said binding material relative to the bound mass in at least one external cross-section layer along said equator [C^{Eq}ₒᵤₜ] is higher than in at least one external cross-section layer along at least one of its parallels of constant latitude, [C^{Pr}ₒᵤₜ];
h. concentration (% wt) of said binding material relative to the bound mass at the outermost external cross-section layer along said equator [C^{Eq}ₒᵤₜ] is higher than at the outermost external cross-section layer along at least one of its parallels of constant latitude, [C^{Pr}ₒᵤₜ];
i. concentration (% wt) of said binding material relative to the bound mass in at least one external cross-section layer along said bales's latitudes [C^{LAT}ₒᵤₜ] is higher than in at least one external cross-section layer along at least one of its meridians or constant longitude [C^{Mer}ₒᵤₜ];
j. concentration (% wt) of said binding material relative to the bound mass at the outermost external cross-section layer along said latitudes of the bale [C^{LAT}ₒᵤₜ] is higher than at the outermost external cross-section layer along at least one of its meridians or constant longitude [C^{Mer}ₒᵤₜ];
k. concentration (% wt) of said binding material relative to the bound mass at one or more external cross-section layers of one or more portions (a) [C^{PORa}ₒᵤₜ] of said bales surface or adjacent external cross-section layers is higher than one or more external cross-section layers of one or more other portions (b) [C^{PORb}ₒᵤₜ];
l. concentration (% wt) of said binding material relative to the bound mass at two or more external cross-section layers of two or more portions (a) [C^{PORa}ₒᵤₜ] of said bale surface or adjacent external cross-section layers is higher than one or more external cross-section layers of one or more other portions (b) [C^{PORb}ₒᵤₜ] so that a net-like enveloping portion of high concentration of said binding material [C^{PORa}ₒᵤₜ] is provided;
m. said administering is selected from one or more members of a group consisting of sprinkling, dripping, wetting, socking, spraying, dousing, dampening, applying a metered dose or otherwise dosing or batching fluid or fluids being in various states, e.g., gas, liquids, solids, flowable fine particles and particulate matter or combination thereof;
n. said administering is provided in a plurality of steps, at least one first step of providing said mass pre-wetted (dry or semi-dry) solid binding materials; and at least one second step of wetting the mass and solid binders by a fluid;
o. said administering is provided in a plurality of steps, at least one first step of providing said mass pre-wetted (dry or semi-dry) solid binding materials; and at least one second step of wetting the mass and solid binders by a fluid; said first and second steps are provided at separate locations and/or separate time; said first and second steps are provided at the same location and/or at the adjacent time; and
p. said administering is provided in a plurality of steps, at least one first step of providing said mass pre-wetted (dry or semi-dry) solid binding materials; and at least one second step of wetting the mass and solid binders by a fluid; said first and second steps are provided at separate locations and/or separate time.

52. The method of claim 51, wherein said mass is cut and raked crop including hay, cotton, flax straw, corn straw, wheat straw, salt marsh hay or silage, or any combination thereof.

53. The method of claim 51, further comprising the step of applying to said mass, wherein said step of applying pressure is applied before, during and/or after the step of administering said binding material to said mass.

54. The method of claim 51, wherein said binding materials are either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from 10 to 1,500 μm; (a)/(b) weight ratio ranging from 100:40 to 0.5:10.

55. The method of claim 54, wherein thermoplasticized natural polymers are utilized, said natural polymers may include lignocellulosic materials and derivatives thereof.

56. The method of claim 51, wherein said biding materials are elected from either or both food grade materials and food contact materials, further wherein at least one of the following is held true:
a. food grade biding materials are selected from a group consisting of cellulose is UFC-100, size ranging from 8 to 10 μm; hard wood cellulose is selected from a group consisting of BE 600-10-TG, size ranging from 18 μm, BE 600-30, size ranging from 30 μm, HB 4115, size ranging from 40 to 110 μm; and soft wood fibers BK 4090, 1,500 μm;
b. food contact materials are selected from a group consisting of soft wood Lignocel selected from a group consisting of CW-630-PU, size ranging from 20 to 40 μm, C-750-FP, size ranging from 40 to 70 μm, C-100, size ranging from 70 to 150 μm, C-320, size ranging from 200 to 500 μm; soft wood fibers HS-250, size ranging from 150 to 350 μm; and
c. food grade propylene glycol and polyvinyl alcohol, 6-88 or 6-96, respectively, are utilizable.

57. The method of claim 51, wherein said binding material is a water-based dispersion and at last one of the following is held true:
a. viscosity ranges between 1,040 cP at 25° C. and 121 cP at 60° C. (Brookfield DV2T).
b. shear strength ranges between 0.7 to 2.7 MPa according to modified ASTM D 905-03 where thin layer of said dispersions applied on 0.7×0.7-inch area of a wooden veneer with dimensions of 150×2×1.5 mm; after open time of 5 to 20 min, the samples were glued, subjected to the static pressure of 3.5 atm for 3 min and allowed to cure at ambient conditions for at least 48 hours or till constant weight; at least 6 cured assemblies were then tested for shear strength at 5 mm/min speed; and
c. Tensile strength was measured according to modified ASTM D 638-02a, at 50 mm/min speed utilizing Instron machine, where said dispersions casted into hand-made rectangular patterns of 1.5×2.0 cm thickness and lateral dimensions of 2×15 cm trays and dried at 25° C. and 30% humidity in the climate chamber for at least 6 days; tensile stress at maximum load ranges between 0.3 to 0.5 MPa and Work from preload (toughness) of 200 to 600 N/mm.

58. A baler comprising a mass compacting module; and a module for administering a binding material within the mass compacting module.

59. The baler of claim 58, wherein said administering module is capable of administering said binding material in a heterogeneous manner, wherein at least one of the following is true:
a. the concentration (% wt) of said binding material at said at least one (i) external cross-section layer (L) [C^{Li}ₒᵤₜ] is higher than said at least one (j) inner cross-section layer [C^{Li}ₒᵤₜ]; i and j are integers each of which is equal to or greater than 1 and [C^{Li}ₒᵤₜ]>[C^{Lj}ᵢₙ];
b. the concentration (% wt) of said binding material at said external cross-section layers decreases so that [C^{Li=n}ₒᵤₜ]>[C^{Li=(n+1)}ₒᵤₜ], n is an integer equal to or greater than 1, where n increases with each successive layer further from the external surface of the bound mass;
c. the concentration (% wt) of said binding material at the outermost external cross-section layer [Cₒᵤₜ] is higher than at the innermost cross-section layer [Cᵢₙ];
d. the concentration (% wt) of said binding material at the outermost cross-section layer is f times higher than at the innermost cross-section layer, and f≥1.5;
e. concentration (% wt) of said binding material relative to the bound mass at the outermost cross-section layer [Cₒᵤₜ]≥0.4%, whilst the concentration of said binding material relative to the bound mass within the innermost cross-section layer [Cᵢₙ]≤0.2%;
f. said bale characterized by a solid geometry having an equator, wherein concentration (% wt) of said binding material relative to the bound mass in at least one external cross-section layer along said equator [C^{Eq}ₒᵤₜ] is higher than within the at least one inner cross-section layer (j) [C^{Lj}ₒᵤₜ];
g. concentration (% wt) of said binding material relative to the bound mass in at least one external cross-section layer along said equator [C^{Eq}ₒᵤₜ] is higher than in at least one external cross-section layer along at least one of its parallels of constant latitude, [C^{Pr}ₒᵤₜ];
h. concentration (% wt) of said binding material relative to the bound mass at the outermost external cross-section layer along said equator [C^{Eq}ₒᵤₜ] is higher than the outermost external cross-section layer along at least one of its parallels of constant latitude, [C^{Pr}ₒᵤₜ];
i. concentration (% wt) of said binding material relative to the bound mass in at least one external cross-section layer along said bales's latitudes [C^{LAT}ₒᵤₜ] is higher than in at least one external cross-section layer along at least one of its meridians or constant longitude [C^{Mer}ₒᵤₜ];
j. concentration (% wt) of said binding material relative to the bound mass at the outermost external cross-section layer along said bales's latitudes [C^{LAT}ₒᵤₜ] is higher than at the outermost external cross-section layer along at least one of its meridians or constant longitude [C^{Mer}ₒᵤₜ];
k. concentration (% wt) of said binding material relative to the bound mass in one or more external cross-section layers of one or more portions (a) [C^{PORa}ₒᵤₜ] of said bales surface or adjacent external cross-section layers is higher than in one or more external cross-section layers of one or more other portions (b) [C^{PORb}ₒᵤₜ];
l. concentration (% wt) of said binding material relative to the bound mass in two or more external cross-section layers of two or more portions (a) [C^{PORa}ₒᵤₜ] of said bales surface or adjacent external cross-section layers is higher than one or more external cross-section layers of one or more other portions (b) [C^{PORb}ₒᵤₜ] so that a net-like enveloping portion of high concentration of said binding material [C^{PORa}ₒᵤₜ] is provided;
m. said administering is selected from one or more members of a group consisting of sprinkling, dripping, wetting, socking, spraying, dousing, dampening, applying a metered dose or otherwise dosing or batching fluid or fluids being in various states, e.g., gas, liquids, solids, flowable fine particles and particulate matter or combination thereof;
n. said administering is provided in a plurality of steps, at least one first step of providing said mass pre-wetted (dry or semi-dry) solid binding materials; and at least one second step of wetting the mass and solid binders by a fluid;
o. said administering is provided in a plurality of steps, at least one first step of providing said mass pre-wetted (dry or semi-dry) solid binding materials; and at least one second step of wetting the mass and solid binders by a fluid; said first and second steps are provided at separate locations and/or separate time; said first and second steps are provided at the same location and/or at the adjacent time; and
p. said administering is provided in a plurality of steps, at least one first step of providing said mass pre-wetted (dry or semi-dry) solid binding materials; and at least one second step of wetting the mass and solid binders by a fluid; said first and second steps are provided at separate locations and/or separate time.

60. The baler of claim 58, wherein said biding materials are elected from either or both food grade materials and food contact materials, further wherein at least one of the following is held true:
a. food grade biding materials are selected from a group consisting of cellulose is UFC-100, size ranging from 8 to 10 μm; hard wood cellulose is selected from a group consisting of BE 600-10-TG, size ranging from 18 μm, BE 600-30, size ranging from 30 μm, HB 4115, size ranging from 40 to 110 μm; and soft wood fibers BK 4090, 1,500 μm;
b. food contact materials are selected from a group consisting of soft wood Lignocel selected from a group consisting of CW-630-PU, size ranging from 20 to 40 μm, C-750-FP, size ranging from 40 to 70 μm, C-100, size ranging from 70 to 150 μm, C-320, size ranging from 200 to 500 μm; soft wood fibers HS-250, size ranging from 150 to 350 μm; and
c. food grade propylene glycol and polyvinyl alcohol, 6-88 or 6-96, respectively, are utilizable as an alternative plasticizer to glycerol.

61. The baler of claim 58, wherein said binding material is a water-based dispersion and at last one of the following is held true:
a. viscosity ranges between 1,040 cP at 25° C. and 121 cP at 60° C. (Brookfield DV2T)
b. shear strength ranges between 0.7 to 2.7 MPa according to modified ASTM D 905-03 where thin layer of said dispersions applied on 0.7×0.7-inch area of a wooden veneer with dimensions of 150×2×1.5 mm; after open time of 5 to 20 min, the samples were glued, subjected to the static pressure of 3.5 atm for 3 min and allowed to cure at ambient conditions for at least 48 hours or till constant weight; at least 6 cured assemblies were then tested for shear strength at 5 mm/min speed; and
c. tensile strength was measured according to modified ASTM D 638-02a, at 50 mm/min speed utilizing Instron machine, where said dispersions casted into hand-made rectangular patterns of 1.5×2.0 cm thickness and lateral dimensions of 2×15 cm trays and dried at 25° C. and 30% humidity in the climate chamber for at least 6 days; tensile stress at maximum load ranges between 0.3 to 0.5 MPa and Work from preload (toughness) of 200 to 600 N/mm.

62. The baler of claim 858, wherein said binding material is a hot-melt and at last one of the following is held true:
a. tensile stress at maximum load ranges between 1.5 to 2.5 MPa; and
b. work from preload (toughness) ranges between 200 to 2100 N/mm.

63. A bale of a mass comprising a binding material administered within said mass, said binding material is configured to bond with said mass, so that at least one of the following is true:
a. the concentration (% wt) of said binding material at said at least one (i) external cross-section layer (L) [C^{Li}ₒᵤₜ] is higher than said at least one (j) inner cross-section layer (j) [C^{Lj}ₒᵤₜ]; i and j are integers each of which is equal to or is greater than 1 and [C^{Li}ₒᵤₜ]>[C^{Lj}ᵢₙ];
b. the concentration (% wt) of said binding material at said external cross-section layers decreases so that [C^{Li=n}ₒᵤₜ]>[C^{Li=(n+1)}ₒᵤₜ], n is an integer equal to or greater than 1, where n increases with each successive layer further from the external surface of the bound mass;
c. the concentration (% wt) of said binding material at the outermost external cross-section layer [Cₒᵤₜ] is higher than at the innermost cross-section layer [Cᵢₙ];
d. the concentration (% wt) of said binding material in the outermost cross-section layer is f times higher than in the innermost cross-section layer, and f≥1.5;
e. the concentration (% wt) of said binding material relative to the bound mass in the outermost cross-section layer [Cₒᵤₜ]≥0.4%, whilst the concentration of said binding material relative to the bound mass within the innermost cross-section layer is [Cᵢₙ]≤0.2%;
f. said bale characterized by a solid geometry having an equator, wherein concentration (% wt) of said binding material relative to the bound mass at the at least one external cross-section layer along said equator [C^{Eq}ₒᵤₜ] is higher than said in at least one inner cross-section layer (j) [C^{Lj}ₒᵤₜ];
g. concentration (% wt) of said binding material relative to the bound mass in at least one external cross-section layer along said equator [C^{Eq}ₒᵤₜ] is higher than in at least one external cross-section layer along at least one of its parallels of constant latitude, [C^{Pr}ₒᵤₜ];
h. concentration (% wt) of said binding material relative to the bound mass in the outermost external cross-section layer along said equator [C^{Eq}ₒᵤₜ] is higher than in the outermost external cross-section layer along at least one of its parallels of constant latitude, [C^{Pr}ₒᵤₜ];
i. concentration (% wt) of said binding material relative to the bound mass in at least one external cross-section layer along said latitudes of the bale [C^{LAT}ₒᵤₜ] is higher than in at least one external cross-section layer along at least one of its meridians or constant longitude [C^{Mer}ₒᵤₜ];
j. concentration (% wt) of said binding material relative to the bound mass in the outermost external cross-section layer along said bales's latitudes [C^{LAT}ₒᵤₜ] is higher than in the outermost external cross-section layer along at least one of its meridians or constant longitude [C^{Mer}ₒᵤₜ];
k. concentration (% wt) of said binding material relative to the bound mass in one or more external cross-section layers of one or more portions (a) [C^{PORa}ₒᵤₜ] of said bales surface or adjacent external cross-section layers is higher than in one or more external cross-section layers of one or more other portions (b) [C^{PORb}ₒᵤₜ];
l. concentration (% wt) of said binding material relative to the bound mass in two or more external cross-section layers of two or more portions (a) [C^{PORa}ₒᵤₜ] of said bales surface or adjacent external cross-section layers is higher than in one or more external cross-section layers of one or more other portions (b) [C^{PORb}ₒᵤₜ] so that a net-like enveloping portion of high concentration of said binding material [C^{PORa}ₒᵤₜ] is provided;
m. said administering is selected from one or more members of a group consisting of sprinkling, dripping, wetting, socking, spraying, dousing, dampening, applying a metered dose or otherwise dosing or batching fluid or fluids being in various states, e.g., gas, liquids, solids, flowable fine particles and particulate matter or combination thereof;
n. said administering is provided in a plurality of steps, at least one first step of providing said mass pre-wetted (dry or semi-dry) solid binding materials; and at least one second step of wetting the mass and solid binders by a fluid;
o. said administering is provided in a plurality of steps, at least one first step of providing said mass pre-wetted (dry or semi-dry) solid binding materials; and at least one second step of wetting the mass and solid binders by a fluid; said first and second steps are provided at separate locations and/or separate time; said first and second steps are provided at the same location and/or at the adjacent time; and
p. said administering is provided in a plurality of steps, at least one first step of providing said mass pre-wetted (dry or semi-dry) solid binding materials; and at least one second step of wetting the mass and solid binders by a fluid; said first and second steps are provided at separate locations and/or separate time.

64. The bale of claim 63, wherein said biding materials are elected from either or both food grade materials and food contact materials, further wherein at least one of the following is held true:
a. food grade biding materials are selected from a group consisting of cellulose is UFC-100, size ranging from 8 to 10 μm; hard wood cellulose is selected from a group consisting of BE 600-10-TG, size ranging from 18 μm, BE 600-30, size ranging from 30 μm, HB 4115, size ranging from 40 to 110 μm; and soft wood fibers BK 4090, 1,500 μm;
b. food contact materials are selected from a group consisting of soft wood Lignocel selected from a group consisting of CW-630-PU, size ranging from 20 to 40 μm, C-750-FP, size ranging from 40 to 70 μm, C-100, size ranging from 70 to 150 μm, C-320, size ranging from 200 to 500 μm; soft wood fibers HS-250, size ranging from 150 to 350 μm; and
c. food grade propylene glycol and polyvinyl alcohol, 6-88 or 6-96, respectively, are utilizable as an alternative plasticizer to glycerol.

65. The bale of claim 63, wherein said binding material is a water-based dispersion and at last one of the following is held true:
a. viscosity ranges between 1,040 cP at 25° C. and 121 cP at 60° C. (Brookfield DV2T)
b. shear strength ranges between 0.7 to 2.7 MPa according to modified ASTM D 905-03 where thin layer of said dispersions applied on 0.7×0.7-inch area of a wooden veneer with dimensions of 150×2×1.5 mm; after open time of 5 to 20 min, the samples were glued, subjected to the static pressure of 3.5 atm for 3 min and allowed to cure at ambient conditions for at least 48 hours or till constant weight; at least 6 cured assemblies were then tested for shear strength at 5 mm/min speed; and
c. tensile strength was measured according to modified ASTM D 638-02a, at 50 mm/min speed utilizing Instron machine, where said dispersions casted into hand-made rectangular patterns of 1.5×2.0 cm thickness and lateral dimensions of 2×15 cm trays and dried at 25° C. and 30% humidity in the climate chamber for at least 6 days; tensile stress at maximum load ranges between 0.3 to 0.5 MPa and Work from preload (toughness) of 200 to 600 N/mm.

66. The method of claim 51, wherein said binding material comprises plastic-free binding materials for baling a crop; said plastic-free binding material comprises less than 0.3 gr and 2.4 gr HDPE and LLDPE per ton silage, respectively, for baling said crops.

67. The method of claim 66, wherein said binding materials are free of polyalkenes, including polyethylene, further wherein said binding material is a water-based dispersion and at last one of the following is held true:
a. viscosity ranges between 1,040 cP at 25° C. and 121 cP at 60° C. (Brookfield DV2T);
b. shear strength ranges between 0.7 to 2.7 MPa according to modified ASTM D 905-03 where thin layer of said dispersions applied on 0.7×0.7-inch area of a wooden veneer with dimensions of 150×2×1.5 mm; after open time of 5 to 20 min, the samples were glued, subjected to the static pressure of 3.5 atm for 3 min and allowed to cure at ambient conditions for at least 48 hours or till constant weight; at least 6 cured assemblies were then tested for shear strength at 5 mm/min speed; and
c. Tensile strength was measured according to modified ASTM D 638-02a, at 50 mm/min speed utilizing Instron machine, where said dispersions casted into hand-made rectangular patterns of 1.5×2.0 cm thickness and lateral dimensions of 2×15 cm trays and dried at 25° C. and 30% humidity in the climate chamber for at least 6 days; tensile stress at maximum load ranges between 0.3 to 0.5 MPa and Work from preload (toughness) of 200 to 600 N/mm.

68. The method of claim 51, wherein said binding material is characterized by one or more of the following: paper and products thereof; edible materials, food grade materials and/or food contact materials, a plastic-free binding material comprising less than 0.3 gr and 2.4 gr HDPE and LLDPE per ton silage, respectively; either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from 10 to 1,500 μm; (a)/(b) weight ratio ranging from 100:40 to 0.5:10; thermoplasticized natural polymers are utilized, said natural polymers may include lignocellulosic materials and derivatives thereof; and any derivative, mixture and combination thereof.

69. The bale of claim 63, enveloped by a supporting material administered outside said mass, said supporting material is configured to bond with said mass, wherein said supporting material is selected from one or more members of a group consisting of paper and products thereof; edible materials, food grade materials and/or food contact materials. a plastic-free binding material comprising less than 0.3 gr and 2.4 gr HDPE and LLDPE per ton silage, respectively; either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from 10 to 1.500 μm; (a)/(b) weight ratio ranging from 100:40 to 0.5:10; thermoplasticized natural polymers are utilized, said natural polymers may include lignocellulosic materials and derivatives thereof; and any derivative, mixture and combination thereof.

70. The baler of claim 58, further comprising a mas-compacting module; and a module for administering a supporting material in connection with said compacted mass; said mass supporting material is selected from a group consisting of one or more members of a group consisting paper and products thereof; edible materials, food grade materials and/or food contact materials, a plastic-free binding material comprising less than 0.3 gr and 2.4 gr HDPE and LLDPE per ton silage, respectively; either or both (i) free-flowing materials selected from a group consisting of lignin, polyvinyl alcohol (PVOH), glycerol, wood fiber, lignocellulose and any mixture, combination and derivative thereof; and (ii) melts, selected from a group consisting of paraffin and (a) lignin, glycerol and any mixture, combination and derivative thereof; and (b) lignocellulose, particles' average size ranging from 10 to 1,500 μm; (a)/(b) weight ratio ranging from 100:40 to 0.5:10; thermoplasticized natural polymers are utilized, said natural polymers may include lignocellulosic materials and derivatives thereof; and any derivative, mixture and combination thereof.
